(19) United States
(12) Patent Application Publication
(10) Pub. No.: US 2026/0288818 A1
(43) Pub. Date: Sep. 24, 2026

(54) SYSTEM

(71) Applicant: SoftBank Group Corp., Tokyo (JP)

(72) Inventor: Hiroyuki MIZUNO, Tokyo (JP)

(73) Assignee: SoftBank Group Corp., Tokyo (JP)

(21) Appl. No.: 19/567,372

(22) Filed: Mar. 16, 2026

(30) Foreign Application Priority Data
Mar. 19, 2025 (JP) 2025-045077

(51) Int. Cl. G06F 16/3329; G06F 40/284; G06F 40/30; G06Q 30/0601

(52) U.S. Cl. CPC G06F 16/33295; G06F 40/284; G06F 40/30; G06Q 30/06311

(57) ABSTRACT

A system includes a processor that is configured to input, to a generative artificial intelligence model, a prompt for instructing the generative artificial intelligence model to search, from a database, related information based on a utilization status of a user and to provide the related information, input, to the generative artificial intelligence model, a prompt for instructing the generative artificial intelligence model to analyze a question from the user by a natural language processing technique and to provide information in an interactive manner based on an analysis result, and input, to the generative artificial intelligence model, a prompt for instructing the generative artificial intelligence model to analyze a purchase history and a utilization tendency of the user and to generate information optimized for the user.

### CROSS-REFERENCE TO RELATED APPLICATION

This application is based on and claims priority under 35 USC 119 from Japanese Patent Application No. 2025-045077 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information provision systems that utilize databases and user profiles typically rely on predetermined rules, static recommendation logic, or limited natural language processing capabilities. Such systems often fail to flexibly interpret diverse user questions expressed in natural language, to adaptively search and select related information from large-scale databases based on the current utilization status of each user, or to generate responses in an interactive dialogue format that matches the user's context and intent. Furthermore, conventional systems usually treat all users in a uniform manner and are not capable of dynamically generating information optimized for individual users based on detailed analysis of purchase histories and utilization tendencies. In addition, most existing systems either ignore user emotions or require dedicated emotion recognition modules that are difficult to integrate with the information generation process, thereby making it challenging to adjust the content, tone, and level of detail of information in accordance with the user's emotional state. Moreover, there is insufficient integration between the generation of information by advanced generative artificial intelligence models and the delivery of such information to user terminals in a form that provides optimal value to the user. As a result, there is a need for a system that can, by appropriately prompting a generative artificial intelligence model, coordinate database search, natural language understanding, emotion recognition, personalized information generation, and transmission of generated information to user terminals in a unified and scalable manner.

### SUMMARY

In order to solve the above-described problems, an aspect of the present invention provides a system comprising a processor, wherein the processor is configured to input, to a generative artificial intelligence model, a prompt for instructing the generative artificial intelligence model to search, from a database, related information based on a utilization status of a user and to provide the related information, input, to the generative artificial intelligence model, a prompt for instructing the generative artificial intelligence model to analyze a question from the user by a natural language processing technique and to provide information in an interactive manner based on an analysis result, and input, to the generative artificial intelligence model, a prompt for instructing the generative artificial intelligence model to analyze a purchase history and a utilization tendency of the user and to generate information optimized for the user. In one embodiment, the processor is further configured to input, to the generative artificial intelligence model, a prompt for instructing the generative artificial intelligence model to recognize an emotion from voice or text of the user and to adjust the information in accordance with the emotion, thereby enabling dynamic adaptation of content and expression style to the user's emotional state within a single generative framework. In another embodiment, the processor is further configured to transmit, to a terminal of the user, information generated based on the prompt by using the generative artificial intelligence model, and to provide optimal information to the user, whereby database search, dialogue-based response generation, emotion-aware adjustment, and personalized recommendation are integrated into an end-to-end system that flexibly responds to individual users and their current situations.

The term “system” refers to an arrangement of hardware components, software components, or a combination thereof, that cooperatively operate to execute the processing described in the present specification and claims.

The term “processor” refers to any hardware circuitry, processing unit, or combination of processing units, including but not limited to a CPU, GPU, ASIC, FPGA, or a plurality thereof, that executes programs or controls operations to perform the functions described in the present specification and claims.

The term “generative artificial intelligence model” refers to a machine learning model, such as a neural network or large language model, that generates output data, including but not limited to text, images, or other content, in response to input data such as prompts.

The term “prompt” refers to data, including but not limited to text, tokens, parameters, or structured information, that is input to the generative artificial intelligence model to instruct the generative artificial intelligence model to perform a specific processing or to generate specific output information.

The term “database” refers to any structured or unstructured data storage system, including relational databases, NoSQL databases, data lakes, or other storage mechanisms, that stores information such as user-related data, purchase history data, utilization status data, or content data to be retrieved and used by the system.

The term “utilization status of a user” refers to information representing how the user uses a service, application, or system, including at least one of access history, usage frequency, interaction patterns, current context, or device status.

The term “related information” refers to information retrieved from the database that has a relationship to the utilization status of the user, the user's question, the user's purchase history, the user's utilization tendency, or any combination thereof, and that is appropriate to be presented to the user.

The term “question from the user” refers to an inquiry, request, or instruction expressed by the user in natural language, including voice input or text input, and provided to the system via a user interface of a terminal.

The term “natural language processing technique” refers to any computational method or algorithm for processing natural language, including at least one of tokenization, part-of-speech tagging, syntactic analysis, semantic analysis, intent detection, or entity recognition, for interpreting or generating natural language.

The term “interactive manner” refers to a mode of information provision in which the system engages in one or more turns of dialogue with the user, and in which the content of information provided in each turn is determined based on previous exchanges or context within the dialogue.

The term “purchase history” refers to data indicating records of products or services purchased by the user, including at least one of purchase time, store or service location, product category, product identifier, quantity, or price.

The term “utilization tendency” refers to patterns or trends derived from the utilization status or purchase history of the user, including at least one of preferred stores, preferred product categories, price sensitivity, time-of-day preferences, or frequency of use.

The term “information optimized for the user” refers to information that is selected, generated, or adjusted based on at least one of the user's utilization status, purchase history, utilization tendency, preferences, or emotional state, so as to increase relevance, usefulness, or convenience to the user.

The term “emotion” refers to a psychological state of the user inferred from voice characteristics, linguistic expressions, or other signals, including for example happiness, sadness, anger, surprise, fear, or neutrality.

The term “voice or text of the user” refers to audio data containing spoken utterances of the user and/or character string data input by the user, which are used as input for recognizing the user's intent, content, or emotion.

The term “adjust the information in accordance with the emotion” refers to modifying at least one of the content, tone, level of detail, structure, or presentation style of the information to be provided to the user, based on the recognized emotion of the user.

The term “terminal of the user” refers to an electronic device operated by the user, including for example a smartphone, tablet, personal computer, smart speaker, or other network-connected device, that communicates with the system and presents information to the user.

The term “information generated based on the prompt” refers to output produced by the generative artificial intelligence model in response to the prompt, including but not limited to answers, recommendations, explanations, summaries, or other content that is to be provided to the user.

The term “optimal information” refers to information that is determined by the system to be most suitable or beneficial for the user at a given time, based on one or more of the utilization status, question, purchase history, utilization tendency, emotion, or context of the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

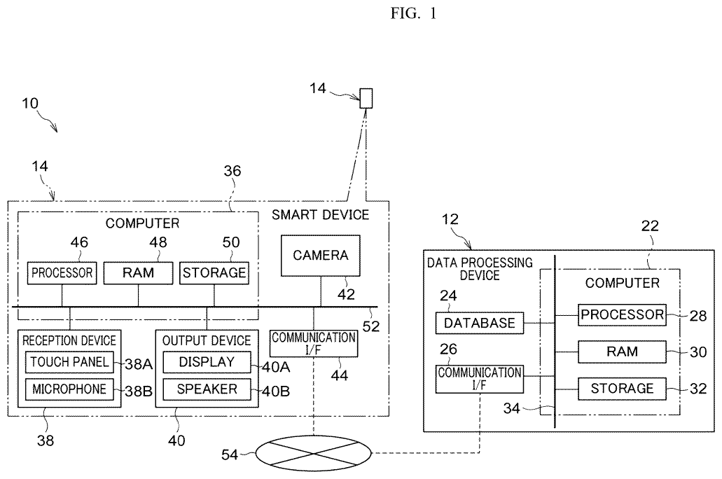

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

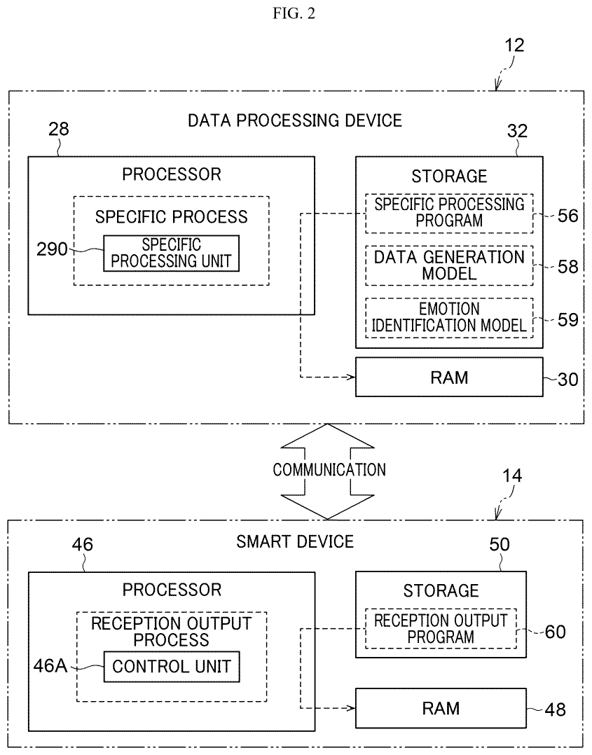

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information provision systems that use databases and dialogue engines often treat natural language understanding, database querying, and response generation as separate and weakly coordinated components. In many existing architectures, an application server parses a user query, executes a fixed database query template, and then displays tabular results or pre-defined message templates. Such systems frequently fail to provide contextually appropriate, concise, and user-tailored explanations of database contents, particularly when multiple heterogeneous records (for example, different facilities and discount conditions) must be summarized for display on a constrained user interface such as a mobile terminal.

Further, in typical systems that incorporate a generative AI model, the model is simply given the user's question and optionally some free-form text, without a precise and machine-controlled linkage between database-derived structured data and the generated natural language output. As a result, the model may generate incomplete explanations, omit important constraints such as validity periods, or hallucinate facilities and discounts that are not actually available in the database. This undermines the reliability and traceability of the system from the perspective of computer system design and data integrity.

Moreover, existing conversation-oriented services generally do not maintain a rigorous, machine-usable dialogue history that is systematically reflected in the construction of prompts to a generative AI model. Multi-turn context is often handled only at the user interface layer, or is passed in an ad hoc manner, which leads to inconsistent query formulation against the database and inconsistent natural language responses. This results in repeated or redundant database access, inefficient resource utilization, and decreased user satisfaction due to erratic behavior across turns in a dialogue.

In addition, conventional systems rarely incorporate user utilization information, such as purchase history and usage tendencies, together with dynamic context such as location and time, directly into a unified pipeline that controls both database query parameters and the content of prompt sentences supplied to a generative AI model. As a consequence, the computational resources of the server and the model are not used efficiently, because large, unfocused result sets are generated, and the generative AI model is forced to handle unnecessary or irrelevant records in every call.

Furthermore, conventional systems that attempt to recognize user emotion or tone often use such recognition only for superficial user interface adaptations, such as changing colors or adding empathetic phrases, without using the emotion signal to shape the data selection logic and the semantic structure of prompts to the generative AI model. This separation leads to under-utilization of available context information and prevents systematic, machine-controlled optimization of response style, detail level, and ordering of information in a way that improves the underlying computer process.

Finally, many prior-art systems that generate natural language messages from database content provide no robust mapping mechanism from generated text back to the underlying structured records. This lack of linkage makes it difficult to create reliable, selectable lists or map-based interfaces on user terminals that are guaranteed to correspond exactly to the data that was summarized by the model. As a result, it becomes complex to synchronize the front-end interactive elements with the back-end database state, which in turn complicates transaction handling, logging, and system maintenance.

Accordingly, there is a need for an improved computer-implemented system that tightly integrates (i) extraction and parameterization of user context and utilization information, (ii) controlled generation of database search conditions, (iii) construction of structured prompt sentences for a generative AI model that encode both structured data and dialogue state, and (iv) deterministic association between generated responses and the underlying structured records. Such an architecture should improve the technical operation of the server and the overall computer system by reducing unnecessary database traffic, constraining the generative AI model to verifiable data, improving consistency over multiple turns of dialogue, and enabling reliable generation of selectable list and map information on user terminals.

The specific processing by the specific processing unit 290 of the data processing device 12 in Example 1 is realized by the following means.

The present invention provides a server comprising a processor and a storage apparatus, the processor being configured to determine search conditions for exploring related information from the storage apparatus based on utilization information of a user and generate inquiry information for the storage apparatus based on the search conditions; analyze question information expressed in a natural language and position information received from a terminal of the user and generate search parameters including at least a facility type, a time condition, a distance condition, and a preference condition of the user on the basis of an analysis result; transmit the inquiry information to the storage apparatus on the basis of the search parameters and acquire search result information including facility information and discount information from the storage apparatus; perform processing to extract and reorder presentation-target information based on the search result information and the utilization information of the user; generate a prompt sentence to be input to a generative AI model based on the search result information and the reordered information, and describe in the prompt sentence at least the question information from the user, the search parameters, and the search result information; input the prompt sentence to the generative AI model so as to cause the generative AI model to generate response information expressed in a natural language and generate presentation information including the response information; transmit the presentation information to the terminal of the user via a communication line and present the facility information and the discount information in an interactive format to the user; and associate a plurality of pieces of the question information and the response information with each other based on dialogue identification information, store dialogue history information, and update content of a subsequent prompt sentence based on the dialogue history information. This enables a tightly integrated, computer-controlled pipeline in which database query generation, generative AI prompt construction, and multi-turn dialogue management are coordinated to reduce redundant processing, constrain the generative AI model to verifiable structured data, maintain consistent context over multiple turns, and reliably produce user-interface-ready information such as selectable lists and map displays on a user terminal, thereby improving the efficiency, reliability, and technical performance of the underlying information processing system.

The term “processor” refers to a hardware or virtual computation unit, such as a central processing unit or a programmable logic device, that executes instructions to perform data processing, control operations, and communication functions of the system.

The term “storage apparatus” refers to a logical or physical information storage component, such as a database system or persistent memory device, that stores structured or unstructured data including facility information, discount information, user information, and dialogue history.

The term “utilization information” refers to data representing past or present behavior of a user, including at least purchase history, facility usage history, coupon usage history, access frequency, and other behavior-related records used for personalization.

The term “search conditions” refers to a set of criteria, constraints, or parameters, derived from user context or utilization information, that specify which records are to be retrieved from the storage apparatus.

The term “inquiry information” refers to a machine-readable request, including at least a query or command, transmitted from the processor to the storage apparatus for retrieving or updating data according to the search conditions.

The term “question information” refers to input data representing a question or request expressed in a natural language by the user, acquired from a user terminal and processed by the system.

The term “natural language” refers to a human language, such as a spoken or written language, that is not limited to predefined command formats and that can contain free-form expressions.

The term “position information” refers to data indicating a geographic position or location, such as coordinates or region identifiers, associated with the user or the user terminal.

The term “search parameters” refers to structured data elements, derived from analysis of the question information and context, that are used for constructing inquiry information to the storage apparatus, including at least facility type, time condition, distance condition, and user preference condition.

The term “facility type” refers to a classification attribute representing a category of a place or service, such as a store, service point, or other facility category used for filtering database records.

The term “time condition” refers to a constraint related to time, such as a date, time-of-day, or validity period, applied when selecting or filtering records in the storage apparatus.

The term “distance condition” refers to a constraint defining an allowable geographic distance or area, such as a radius around a position, for limiting the facilities to be considered in a search.

The term “preference condition” refers to a condition representing a user's preferences, tendencies, or priorities, derived from utilization information or explicit settings, and used for ranking or filtering information.

The term “search result information” refers to data returned from the storage apparatus in response to the inquiry information, including at least facility information and discount information that satisfy the search parameters.

The term “facility information” refers to data elements that describe a facility, including at least an identifier, a name, a location, and optional attributes such as category or opening hours.

The term “discount information” refers to data elements that describe a discount, benefit, or special offer, including at least a discount rate, applicable conditions, and a validity period.

The term “presentation-target information” refers to a subset of the search result information, selected and ordered for display or communication to the user according to relevance and system rules.

The term “generative AI model” refers to a trained machine learning model that generates natural language or other output content based on input data, including at least models based on neural network architectures.

The term “prompt sentence” refers to a machine-constructed sequence of symbols, including at least text instructions and embedded data, that is supplied as input to the generative AI model to control the content and style of the output.

The term “response information” refers to data output by the generative AI model in response to the prompt sentence, expressed in natural language and describing facilities, discounts, or other information to be presented to the user.

The term “presentation information” refers to data prepared for delivery to the user terminal, including at least the response information and associated structured elements that support user interface rendering.

The term “communication line” refers to a wired or wireless communication path, including at least a packet-based network, through which data is transmitted between the server and the user terminal.

The term “interactive format” refers to a presentation style that enables bidirectional exchange of information between the user and the system, including at least dialogue-like sequences of questions and responses.

The term “dialogue identification information” refers to data that identifies a particular dialogue or session, used to associate multiple turns of question information and response information with one another.

The term “dialogue history information” refers to stored data representing a sequence of past question information and response information within one or more dialogues, used to maintain conversational context.

The term “emotional state” refers to a condition inferred from user input, such as text or voice, representing at least sentiment, mood, or attitude of the user.

The term “expression format” refers to characteristics of how information is expressed in natural language, including at least tone, politeness level, and sentence structure.

The term “detail level” refers to a degree of granularity or amount of information included in a response, such as summary-level information or highly detailed explanations.

The term “presentation order” refers to an arrangement or sequence in which multiple pieces of information are presented to the user within a response or user interface.

The term “structured data” refers to data that conforms to a predefined schema or format, such as records with named fields, which can be processed systematically by a program.

The term “facility expression” refers to a text expression in the response information that refers to a facility, such as a facility name or description.

The term “discount expression” refers to a text expression in the response information that refers to a discount or benefit, such as a percentage-off expression or a description of applicable conditions.

The term “list information” refers to data that represents multiple items, such as facilities or discounts, in an ordered or indexed structure suitable for selection by the user in a user interface.

The term “map display information” refers to data that enables rendering of facilities or related items on a geographic map, including at least location coordinates and identifiers linked to the underlying structured data.

The term “user terminal” refers to an information processing device operated by the user, such as a mobile device, a personal computer, or another computing apparatus capable of communication with the server.

In one embodiment, a server cooperates with a terminal operated by a user to provide facility information and discount information in an interactive manner. The server includes at least one processor, a main memory, a non-volatile storage apparatus, and a network interface. The terminal includes an input interface, a display unit, a local memory, and a communication interface. The user operates the terminal to transmit natural-language question information and contextual data to the server over a packet-based communication network, such as the Internet, using a transport protocol such as TCP/IP and an application protocol such as HTTPS.

The server uses a general-purpose processor, such as a central processing unit or a graphics processing unit, to execute software modules implementing natural language analysis, database access, prompt sentence generation, and generative AI model inference control. The server stores structured data, including facility information, discount information, user utilization information, and dialogue history information, in a relational database management system, such as a database engine implementing SQL. The server also stores one or more trained generative AI models, for example, transformer-based neural network models, on a storage apparatus such as a solid-state drive.

The server uses an application layer program, such as a web service implemented with a server-side framework, to receive question information and position information from the terminal. The server analyzes the question information using a natural language processing library or a small classification model that outputs an intent label and entity labels. The server converts the analysis result into search parameters, including facility type, time condition, distance condition, and preference condition, and then generates structured query data to be transmitted to the database engine. The server uses database indices on facility category, geographic coordinates, and validity periods to efficiently extract search result information satisfying the search parameters.

The server maintains utilization information that includes records of past purchases, redeemed discounts, frequently visited facilities, and access history associated with a user identifier. The server stores this utilization information in normalized tables with foreign keys linking to facility records and discount records. The server generates search conditions by combining the utilization information with the current search parameters in order to prioritize facilities that match a user's historical tendency. For example, the server can give higher rank to facilities that the user accessed frequently in the past month, or can exclude discount records already used by the user.

The server generates a prompt sentence for a generative AI model in a deterministic and machine-controlled manner. The server embeds, within a single text sequence, (i) instructions describing how the model should respond, (ii) the user's original question information, (iii) a textual representation of the search parameters, and (iv) a compact, structured representation of the search result information. The server applies formatting rules that convert database records into a textual list with explicit field labels, such as “facility_name”, “discount_rate”, and “valid_until”, so that the mapping between generated language and underlying data remains traceable.

In one example, the server generates a prompt sentence such as:

“You are an assistant that explains facility coupons based only on the data provided below. Do not invent any coupons or facilities that are not listed. The user question is: ‘Are there any coupons I can use at nearby cafes?’ The search parameters are: facility_type=cafe, distance <=1000 meters, time_condition=today. The database returned the following coupon records: 1) facility_name: Cafe B, distance_in_meters: 250, discount_rate: 20% off, valid_until: today 20:00, conditions: one drink purchase required. 2) facility_name: Cafe C, distance_in_meters: 600, discount_rate: 10% off, valid_until: tomorrow 22:00, conditions: no additional conditions. Please summarize these coupons in simple language suitable for a smartphone screen, prioritize closer facilities, and clearly mention the discount rate and validity period.”

In another example, the server generates a prompt sentence such as:

“Explain step by step how a user can use the available coupons for a particular supermarket today. The user question is: ‘Do I have any coupons for this supermarket today?’ The database returned two coupons: (A) discount_rate: 15% off for all fresh food, valid_until: today 21:00, conditions: minimum purchase amount required. (B) discount_rate: 5% off for all items, valid_until: today 23:00, conditions: no additional conditions. Describe these coupons concisely and explain which coupon is more advantageous in typical situations.”

The server implements the generative AI model as a transformer-based neural network that includes an embedding layer, multiple attention-based encoder-decoder blocks, and an output projection layer. The server stores model parameters, such as weight matrices and bias vectors, in the storage apparatus. The server uses a sequence of numerical tokens representing the prompt sentence as input to the model, where each token corresponds to a subword or word representation. During inference, the server executes matrix multiplications, layer normalization, and non-linear activation functions in a fixed sequence defined by the model architecture. The server controls sampling parameters, such as temperature and top-k values, to generate deterministic or constrained response information that adheres closely to the prompt sentence.

The server trains the generative AI model in an offline environment using a corpus of example dialogues and structured data descriptions. The server defines a loss function, such as cross-entropy between predicted tokens and ground truth tokens, and updates the model parameters by an optimization algorithm, such as stochastic gradient descent with adaptive learning rates. The server may apply data augmentation techniques, such as paraphrasing user questions and shuffling order of coupon records, to increase robustness. During training, the server supplies training input sequences that include both user questions and database-derived records, so that the model learns to reference only provided data when generating response information.

The server uses a dialogue management module to generate and maintain dialogue identification information for each interaction session. The server associates each received question information and each generated response information with a dialogue identifier, and stores them in the storage apparatus as dialogue history information. The server selectively includes parts of the dialogue history in subsequent prompt sentences in order to maintain context, such as the last recommended facility, while avoiding excessive prompt length. The server applies rules that restrict the included history to relevant turns, for example, the most recent N question-response pairs related to the same facility type.

The server further estimates an emotional state of the user from text or voice signals. When the terminal transmits voice data, the server performs feature extraction, such as computing Mel-frequency cepstral coefficients, and feeds these features to an emotion classification model, such as a shallow neural network or a support vector machine. When the terminal transmits text input, the server uses a sentiment analysis module that assigns scores for positive, neutral, or negative sentiment. The server then adjusts the expression format, detail level, and presentation order in the prompt sentence to match the emotional state. For instance, when the user appears frustrated, the server shortens the response, emphasizes the most useful discounts first, and inserts instructions in the prompt sentence requiring the generative AI model to provide direct and concise answers.

The server associates response information generated by the generative AI model with structured data in the storage apparatus. To achieve this, the server inserts unique record identifiers into the structured part of the prompt sentence and applies pattern constraints for facility and discount expressions, such that the generated text can be parsed to recover references to those identifiers. The server stores a mapping table between identifiers and human-readable facility names and discount descriptions. When the generative AI model outputs a response, the server scans the response information for facility expressions and discount expressions and matches them against the identifiers or controlled labels. In this way, the server can construct list information and map display information that exactly correspond to the records summarized in the response.

The terminal displays the presentation information as an interactive user interface. The terminal renders the response information as text and the associated list information as selectable items. The terminal may also use a map rendering library to draw icons on a map surface according to the geographic positions contained in the map display information. The user can select a facility or discount item, and the terminal transmits the selection event to the server, which then can log the selection in the utilization information and update future search conditions.

The server improves technical performance of the overall system by reducing redundant processing and by limiting the input space for the generative AI model. The server constructs narrow and targeted search parameters based on utilization information, position information, and preference conditions, thereby reducing the number of records retrieved from the storage apparatus. As a result, the server lowers the load on the storage apparatus and decreases query latency. The server also encodes only relevant and pre-filtered records into the prompt sentence, so that the generative AI model processes a smaller number of tokens, which reduces inference time and computational resource usage.

The server enhances accuracy and reduces errors by ensuring that the generative AI model operates within explicit constraints embedded in the prompt sentence. The server explicitly instructs the model not to generate facilities or discounts that are absent from the listed records. Because the server controls both the selection of records and the structure of the prompt sentence, the generated response information remains logically consistent with the structured data. This approach differs from manual or human-based processing, where humans could overlook certain validity periods or conditions, and also differs from naive automation that merely forwards free-form text to a generative AI model without structured constraints.

The server implements non-conventional processing rules for constructing prompt sentences and managing dialogue history. The server does not simply append entire conversation transcripts to each prompt; instead, the server uses a rule set that selects only contextually relevant segments and compresses them into summaries or references. This selective history inclusion reduces communication load between prompt generation and model inference, and it prevents unnecessary token expansion in the model input. As a result, the system achieves a technical effect of improved computation efficiency and reduced memory consumption compared to systems that blindly send full logs to the model.

The server can adopt variations in the neural network architecture and processing pipeline. In one embodiment, the server uses a single large generative AI model shared by all users. In another embodiment, the server uses a smaller on-device generative AI model deployed on the terminal for preliminary summarization, and a larger server-side model for final response generation. In yet another embodiment, the server combines a retrieval module using vector embeddings with the relational database retrieval, where the retrieval module uses an embedding model to compute similarity scores between user questions and facility descriptions, and integrates those scores into the search parameters.

The server can also apply alternative machine learning methods for emotion recognition, preference prediction, or ranking of discount information. For example, the server can use gradient boosting decision trees to compute a ranking score for each coupon based on features such as distance, expected savings, and recent usage patterns. The server then uses these ranking scores to determine the order of records in the prompt sentence, so that the generative AI model naturally emphasizes the most relevant entries. This algorithmic ordering improves the interpretability and usefulness of generated responses and directly contributes to reduced cognitive load on the user.

The terminal can be implemented as a smartphone, a tablet, or a personal computer, and may run a native application or a web browser. The terminal uses device-specific hardware, such as a GPS receiver and an accelerometer, to provide accurate position information and context to the server. This hardware-level integration allows the server to restrict searches to physically reachable facilities and to reduce unnecessary database access for distant or irrelevant locations.

The system as a whole improves computer technology by tightly integrating structured database operations, deterministic prompt sentence generation, and constrained generative AI inference. The server implements specific data structures for dialogue history, utilization information, and prompt templates, and controls the flow of data among these structures. Because the server shapes both the data retrieval and the generative model behavior, the system goes beyond mere automation of human tasks and instead achieves measurable improvements in processing speed, resource utilization, and accuracy of information presentation in a multi-turn, context-sensitive environment.

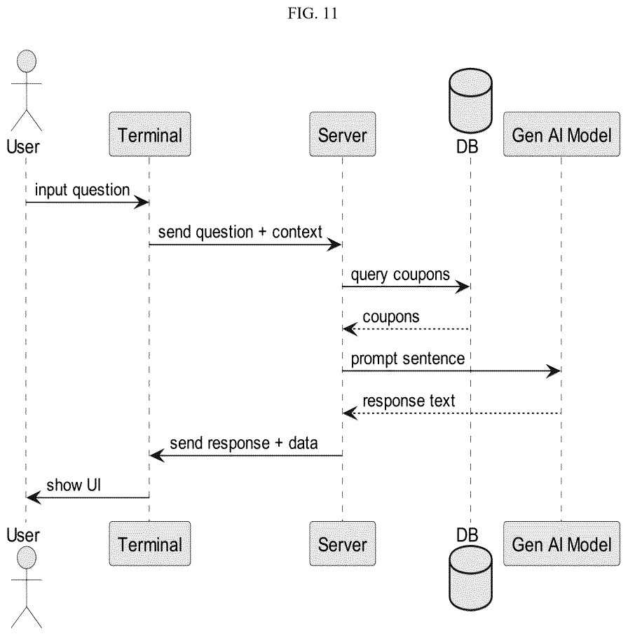

The following describes the processing flow using FIG. 11.
Step 1:

The user operates the terminal to input a natural-language question.

The terminal receives text input such as “Are there any coupons I can use at nearby cafes?” together with implicit context such as the current time. As input, the terminal accepts keystrokes or voice-recognition output from the user and converts this into a Unicode text string. As output, the terminal produces a structured request object in memory that includes at least the question text and a temporary interaction identifier.
Step 2:

The terminal acquires contextual information and prepares a transmission payload.

The terminal obtains position information from a location service, reads a user identifier and language settings from local storage, and includes a timestamp from a system clock. As input, the terminal uses the previously created request object and device-level APIs for location, user profile, and system time. The terminal then constructs a JSON payload or equivalent structured data containing fields such as user_id, question_text, latitude, longitude, timestamp, and locale. As output, the terminal generates a serialized byte sequence that is ready to be sent over an HTTPS connection.
Step 3:

The terminal transmits the request to the server via a communication network.

The terminal sends the serialized payload using a network stack implementing TCP/IP and HTTPS and targets a predefined endpoint URL of the server. As input, the terminal uses the byte sequence representing the request and network configuration parameters such as the server address and security certificates. The terminal performs encryption, packetization, and retransmission control to ensure reliable delivery. As output, the terminal generates network packets that are delivered to the server and then waits for an HTTP response.
Step 4:

The server receives and validates the request from the terminal.

The server accepts incoming network packets through a network interface, reconstructs the HTTPS message, and deserializes the JSON payload into an internal data structure. As input, the server uses the encrypted HTTP request and applies decryption, integrity checks, and JSON parsing. The server verifies authentication tokens, checks that mandatory fields (user_id, question_text, latitude, longitude) are present, and that coordinate values are within valid ranges. As output, the server creates a validated request context object containing user identity, question text, raw position information, and session or dialogue identification information.
Step 5:

The server retrieves utilization information and user profile data.

The server connects to a storage apparatus implementing a relational database and executes parameterized SQL queries based on the user identifier. As input, the server uses the validated request context and a database connection handle. The server queries tables that store purchase history, coupon usage history, frequently accessed facilities, and user preference flags. The server may perform joins between user tables and facility or discount tables. As output, the server produces utilization information in memory, organized as structured arrays or objects representing past user behavior and preferences.
Step 6:

The server performs natural language analysis of the question.

The server passes the question text to a natural language processing component, such as a tokenizer and an intent classification module. As input, the server uses the raw question_text and, optionally, language metadata. The server segments the text into tokens, identifies key phrases, and applies a trained classifier that outputs an intent label (for example, “search_nearby_coupons”) and entity labels (for example, “cafe” as facility category, “today” as time expression). As output, the server generates an analysis result object that encodes the intent, extracted entities, and confidence scores.
Step 7:

The server constructs search parameters from the analysis result and context.

The server combines the intent label, entity information, position information, utilization information, and current time to derive search parameters for database queries. As input, the server uses the analysis result object, the user's latitude and longitude, the current timestamp, and the utilization information. The server calculates a distance condition (for example, radius in meters), determines a facility type (for example, cafes or supermarkets), derives a time condition (for example, valid coupons today or within the next hours), and sets a preference condition (for example, prioritize chains frequently used by the user). As output, the server produces a search parameter structure that includes facility_type, time_condition, distance_condition, and preference_condition fields.
Step 8:

The server generates and executes database queries based on the search parameters.

The server formulates SQL statements or equivalent query language expressions that join facility tables and discount tables and filter records according to the search parameters. As input, the server uses the search parameter structure and schema information of the database. The server computes geographic distances using a formula such as the Haversine equation, either in SQL functions or in application logic, and restricts facility records within the distance_condition. The server also applies conditions on validity periods and user segments derived from the utilization information. As output, the server obtains search result information from the storage apparatus in the form of rows containing fields such as facility_name, coordinates, discount_rate, valid_from, valid_until, and usage_conditions.
Step 9:

The server filters, scores, and orders the search result information.

The server processes the raw search results to select presentation-target information. As input, the server uses the list of result rows and the preference_condition. The server discards expired or inapplicable discounts, calculates ranking scores based on distance, expected saving amount, and user preference matches, and sorts records according to these scores. The server may also group similar discounts or merge overlapping offers. As output, the server generates an ordered, filtered list of coupon records designated as presentation-target information.
Step 10:

The server prepares structured data for prompt sentence generation.

The server converts the ordered coupon records into a compact textual representation that preserves key fields and identifiers. As input, the server uses the presentation-target information, including facility identifiers, discount parameters, and validity data. The server formats each record into a text line with labeled attributes, such as “facility_name: X, distance_in_meters: Y, discount_rate: Z, valid_until: T, conditions: C,” and optionally attaches record identifiers for later mapping. As output, the server generates a structured text block that can be embedded directly into a prompt sentence.
Step 11:

The server generates a prompt sentence for a generative AI model.

The server assembles instruction text, question information, search parameters, and the structured text block into a single prompt sentence. As input, the server uses the original question text, the search parameter structure, the structured coupon text block, and optionally dialogue history information. The server concatenates these elements using predetermined templates, inserts explicit constraints such as “Do not invent facilities or coupons that are not listed,” and specifies the expected style, length, and ordering of the response. As output, the server produces a final prompt sentence in natural language that defines the exact input to the generative AI model.
Step 12:

The server encodes the prompt sentence and performs generative AI inference.

The server tokenizes the prompt sentence using a vocabulary associated with the generative AI model, converts tokens into numerical indices, and feeds them into the model's input embedding layer. As input, the server uses the prompt sentence and model parameters stored on the storage apparatus. The server executes a sequence of matrix multiplications, attention operations, and non-linear activations across multiple transformer layers, and applies a decoding algorithm such as greedy decoding or top-k sampling to generate output token sequences. As output, the server obtains a sequence of output tokens that represent the response information in natural language.
Step 13:

The server decodes and post-processes the response information.

The server converts the output token sequence into a human-readable text string using the model's tokenizer, then applies formatting rules and safety checks. As input, the server uses the output token sequence and the mapping between token indices and subwords or words. The server verifies that facility expressions and discount expressions in the response text correspond only to records in the structured coupon text block, removes or flags any extraneous content, and inserts line breaks or bullet points suitable for display on the terminal. As output, the server produces validated response information ready for inclusion in presentation information.
Step 14:

The server associates the response information with underlying structured data and constructs presentation information.

The server scans the response text to detect references to facility names and discount phrases that match the identifiers included in the prompt sentence. As input, the server uses the validated response information and the mapping between record identifiers and structured coupon records. The server creates list information by pairing each referenced facility expression with its corresponding structured record and generates map display information by attaching geographic coordinates to each facility. As output, the server composes presentation information that includes the response text, the structured list information, and the map display information.
Step 15:

The server updates dialogue history and logs utilization-related events.

The server stores the current question information, response information, and any selected records into dialogue history tables and log tables. As input, the server uses the dialogue identification information, the original question text, the generated response text, and identifiers of the coupons included in the presentation. The server inserts these into persistent storage as new records, and may compute summary statistics or update preference scores based on observed interactions. As output, the server maintains an updated dialogue history and refined utilization information that can be used in subsequent interactions.
Step 16:

The server transmits the presentation information to the terminal.

The server converts the presentation information into a response payload, such as JSON containing the response text, list entries, and map coordinates, and wraps it in an HTTP response. As input, the server uses the presentation information object and the session context associated with the request. The server serializes the data, applies encryption and integrity protection, and sends the resulting packets through the network interface. As output, the server generates an HTTP response message delivered to the terminal.
Step 17:

The terminal receives the response payload and reconstructs the presentation information.

The terminal accepts network packets from the communication interface, reassembles the HTTPS response, and deserializes the JSON payload or equivalent structure. As input, the terminal uses the encrypted byte stream sent by the server and local cryptographic keys. The terminal performs decryption, verifies integrity, and parses the structured data into in-memory objects representing the response text, list information, and map display information. As output, the terminal obtains ready-to-render data structures.
Step 18:

The terminal renders the interactive user interface based on the presentation information.

The terminal displays the response text in a text area and presents the list information as selectable items, and optionally overlays icons on a map for each facility using map display information. As input, the terminal uses the presentation data structures and device-specific UI libraries. The terminal creates visual components, such as list views or buttons, binds each item to a coupon identifier, and positions map markers according to geographic coordinates. As output, the terminal generates a graphical user interface on the display unit, allowing the user to see and select facilities or discounts.
Step 19:

The user interacts with the rendered interface to obtain details or perform follow-up queries.

The user taps or clicks on a facility or coupon item, or inputs another natural-language question, such as “Do you have any dessert coupons at this cafe?” As input, the user uses the physical input devices of the terminal (touchscreen, keyboard, or pointing device) to generate events. The user's actions cause the terminal to send selection signals or new question information to the server, possibly including the same dialogue identification information, so that later processing continues the conversation. As output, the user initiates new requests or detail views that trigger further processing cycles in the server.
Step 20:

The terminal transmits user selections or follow-up questions, and the server reuses context to refine processing.

The terminal creates another request payload that includes the new question or selection event and the current dialogue identification information, then sends this payload to the server via the network. As input, the terminal uses the user's interaction events and existing session data. The server receives this follow-up request, retrieves the relevant dialogue history using the dialogue identification information, and modifies the subsequent search parameters and prompt sentence to reflect the ongoing context, such as “the same cafe” or “today's coupons only.” As output, the server starts a new iteration of the described processing flow, but with refined conditions and reduced need for re-computation, leading to faster and more contextually consistent responses.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information recommendation systems that operate on networked computing environments typically perform static retrieval of content based on simple user attributes or past behavior, without deeply integrating real-time contextual data such as the user's current geographic position and the set of time-varying commercial offers actually available in the vicinity. In such systems, a server generally applies fixed business rules or simple filtering logic to a database and then transmits the resulting list of items to a user terminal. These approaches suffer from several technical limitations.

First, conventional systems do not efficiently exploit the processing capabilities of modern generative AI models in a manner that is tightly constrained by concrete, real-world data maintained by the server. When a conversational interface is added on top of a traditional recommendation engine, the natural-language understanding and the data retrieval often run as loosely coupled subsystems. As a result, the system may either ignore relevant structured data at the time of generating responses, or it may redundantly retrieve large data sets from storage and then perform inefficient post-filtering. This leads to increased processor load on the server, unnecessary data transfers between the server and the generative AI model, higher network usage, and latency that degrades the user experience.

Second, existing systems that attempt to use generative AI for recommendations can produce responses that are not aligned with the actual state of databases managed by the server. For example, a generic conversational model may hallucinate facilities or discounts that are not present or no longer valid in the server-side storage. The lack of a mechanism that explicitly embeds server-side situation information—such as current location information, facility information, and price benefit information—into structured prompt sentences causes inconsistency between the generated response and the real-time system state. This inconsistency reduces reliability and requires additional safeguards or manual checks, further increasing computational overhead.

Third, many known systems treat user emotional state, real-time context, and historical preferences as separate dimensions that are processed in isolation. The server may attempt to personalize information based on purchase history or usage tendencies, while emotional analysis, if present, is executed by a separate module and not reflected in the data retrieval or prompt construction logic. Without an integrated architecture in which a processor generates prompt sentences that simultaneously reflect current location, available commercial information, user history, and user emotional state, the system cannot fully leverage computational resources to produce contextually optimized and technically constrained responses.

Fourth, from the standpoint of computer technology, there is no standardized mechanism for the server processor to programmatically construct prompt sentences as machine-interpretable control instructions that bind the generative AI model to the precise contents of the server's storage. In typical deployments, prompts are ad hoc, application-level strings, not systematically derived from structured situation information. This leads to brittle behavior, difficulty in scaling, and inability to guarantee that the generated output remains within the bounds of the available data. Consequently, server resources are not used in an optimal way, and responses may require costly post-processing or repeated calls to the generative AI model.

Accordingly, there is a need for an improved computer-implemented system in which a processor on a server side generates and inputs structured prompt sentences to a generative AI model, the prompt sentences explicitly encoding current location information, facility information, price benefit information, user behavior history information, and user emotional state information as context. By doing so, the system should technically improve server-side processing by reducing unnecessary data retrieval, constraining model outputs to the actual situation information stored in the server's storage device, and improving the efficiency and reliability of interactive responses delivered to portable terminal devices in real time.

The specific processing by the specific processing unit 290 of the data processing device 12 in Application Example 1 is realized by the following means.

The present invention provides a server comprising a processor and a storage device, the processor being configured to receive user behavior history information and, based on the user behavior history information, input a first prompt sentence to a generative AI model so as to instruct the generative AI model to search related information from the storage device and to provide the related information, to receive current location information of a user from a portable terminal device and, based on the current location information, search facility information existing within a predetermined range from the storage device, to acquire price benefit information associated with the facility information from the storage device and immediately notify the price benefit information to the portable terminal device of the user, to receive inquiry information expressed in natural language from the user, analyze the inquiry information, and, based on the inquiry information, the current location information, and the price benefit information, input a second prompt sentence to the generative AI model so as to instruct the generative AI model to generate response information in an interactive format, to analyze purchase history information and usage tendency information of the user and, by combining the purchase history information and the usage tendency information with the current location information, input a third prompt sentence to the generative AI model so as to instruct the generative AI model to generate information optimized for the individual user, to recognize an emotional state from voice information or character information of the user and, based on the emotional state, the current location information, and the price benefit information, input a fourth prompt sentence to the generative AI model so as to instruct the generative AI model to adjust at least one of content and presentation format of information to be provided, and to generate a further prompt sentence including situation information comprising the current location information, the facility information, and the price benefit information as context and input the further prompt sentence to the generative AI model so as to control the generative AI model to generate only response information consistent with the situation information, and to transmit the response information and the price benefit information generated by the generative AI model based on respective prompt sentences to the portable terminal device and control the portable terminal device so that the response information and the price benefit information are displayed on the portable terminal device. This enables technical improvements in computer functionality by causing the server-side processor to construct structured, situation-aware prompt sentences that bind the generative AI model to concrete data stored in the storage device, thereby reducing unnecessary data transfer and post-processing, constraining model output to real-time location-dependent and user-specific information, decreasing response latency, and increasing the reliability and efficiency of interactive information delivery within the computing system.

The term “processor” refers to a hardware or virtual processing unit, such as a central processing unit or a processing core, that executes instructions of a program to perform arithmetic operations, logical operations, control operations, and data transfer operations.

The term “storage device” refers to a hardware or virtual memory component, such as a main memory or a secondary storage, that stores programs, data, and models used by the processor for execution and processing.

The term “user behavior history information” refers to data indicating past actions of a user in a system, including at least records of accessed content, executed operations, and interaction patterns over time.

The term “purchase history information” refers to a subset of user behavior history information that includes records of items or services acquired by the user, together with at least one of transaction time, transaction location, and transaction amount.

The term “usage tendency information” refers to information derived from user behavior history information, indicating statistical tendencies or preferences of the user, such as frequently selected item categories, time periods of activity, and preferred types of offers.

The term “current location information” refers to positional data representing a physical position associated with a user or a terminal device, including at least one of geographic coordinates and a region identifier.

The term “portable terminal device” refers to an electronic apparatus that can be carried by a user and that includes at least a communication function, a display function, and a function for executing an application program.

The term “facility information” refers to data indicating a commercial or service-providing entity, including at least one of a facility identifier, a facility category, a position of the facility, and attribute information about the facility.

The term “price benefit information” refers to data representing an advantage related to a price of a product or service, including at least one of discount information, coupon information, special offer information, and usage condition information.

The term “inquiry information” refers to information expressing a request or question from a user, the information being represented in a natural language form such as a text string or speech-recognized text.

The term “response information” refers to information generated in accordance with inquiry information and situation information, and presented to a user as an answer, explanation, recommendation, or guidance.

The term “interactive format” refers to a representation format of response information that supports multi-turn exchanges between a user and a system, including at least successive question-and-answer style communication.

The term “emotional state” refers to a condition of a user's emotion inferred from user data, such as voice information or character information, and including at least one of positive, negative, neutral, or more detailed affective categories.

The term “voice information” refers to audio data acquired from speech of a user through an input device, such as a microphone, and optionally processed into a digitized or feature-extracted representation.

The term “character information” refers to symbolic data representing text input or textual content associated with a user, including at least one of typed text, transcribed speech text, and message text.

The term “generative AI model” refers to a computational model that receives a prompt sentence as input and generates output information, such as natural language text, by probabilistic or neural network-based generation.

The term “prompt sentence” refers to a text sequence or structured input string that instructs a generative AI model regarding a task to be performed, including at least one of a system role description, context information, and a user request.

The term “situation information” refers to combined information representing a current state around a user, including at least the current location information, the facility information, and the price benefit information relevant to the user.

The term “context” refers to information included in or associated with a prompt sentence that conditions output of the generative AI model, the information including at least a portion of the situation information and user-related data.

The term “related information” refers to information retrieved from a storage device that is determined to have a relationship with user behavior history information or an inquiry of a user, such as associated content records or recommended items.

In one embodiment, a server, a terminal, and a user cooperate to realize the claimed system. The server comprises at least one processor, one or more storage devices, a network interface, and optionally a hardware accelerator such as a graphics processing unit. The terminal comprises a processor, a wireless communication module, a location acquisition module, a microphone, a display, and an input interface. The user operates the terminal to allow the terminal and the server to execute the processing described below.

The server stores, in the storage device, a plurality of data structures including user behavior history information, purchase history information, usage tendency information, facility information, price benefit information, and learned parameters of a generative AI model. For example, the server stores facility information as records each having a facility identifier, a geographic coordinate pair, a category identifier, and attribute fields. The server stores price benefit information as records each associated with a facility identifier and including at least a discount type, a discount rate, a validity period, and one or more condition flags. The server stores user behavior history information as event logs referencing user identifiers, timestamps, operation types, and contextual attributes. The server further stores situation information derived from these records in an index structure such as a geospatial index or a key-value index to support efficient retrieval.

The terminal uses a location acquisition module, such as a global navigation satellite system receiver and an operating-system location framework, to obtain current location information of the user. The terminal converts raw sensor signals into latitude and longitude values and an accuracy value and transmits the current location information to the server via a wireless communication channel. The terminal also presents a graphical user interface on the display and receives text input and voice input from the user through the input interface and the microphone.

The server stores and executes a computer program that implements prompt construction logic, data retrieval logic, and model invocation logic. The server uses a generative AI model implemented, for example, as a transformer-based neural network that has multiple attention layers, feed-forward layers, and layer normalization components. The server stores model parameters that have been trained in advance on natural language corpora and fine-tuned on domain-specific dialogue and recommendation data.

The server represents user behavior history information and situation information as tokenized text sequences and structured tags that can be embedded into prompt sentences for the generative AI model. For example, the server constructs a prompt sentence in the following form:

“You are an assistant that recommends real, currently available coupons based only on the provided data.

User's current location: latitude 35.6812, longitude 139.7671.

Nearby facilities and coupons: [facility A: supermarket, 0.8 km, 10% off coupon valid until today; facility B: department store, 1.2 km, 5 USD off coupon].

User's question: ‘Are there any 10%-off coupons I can use at a supermarket within 1 km?’

Based on the above data, answer in concise English. Only mention facilities and coupons that are included in the list and that are within 1 km.”

The server uses specific tokenization rules to delimit sections within the prompt sentence, including explicit markers for system role, context, and user utterance. The server encodes these sections into token sequences that are fed into the generative AI model. The server applies a predetermined set of hyperparameters, including a low sampling temperature, a limited maximum output length, and deterministic decoding settings, to constrain the model output and reduce variation.

The server improves computer technology by using a non-conventional integration of server-side data structures and model prompt construction. The server does not simply forward a natural language question to a model; instead, the server generates structured prompt sentences that embed explicit references to server-side data such as current location information, facility information, and price benefit information. The server thereby constrains the solution space of the generative AI model to the contents of the storage device, which reduces the need for transmitting large unfiltered data sets to the model and reduces unwanted or inconsistent output. As a result, the server lowers network communication overhead, reduces the number of post-processing operations, and improves response time.

The server uses a particular data processing flow inside the generative AI model. The generative AI model receives the prompt sentence and maps input tokens to embeddings, feeds the embeddings through a stack of multi-head self-attention blocks, and computes, for each token position, attention weights over previous tokens. The server configures the model so that tokens representing location, facility, and price benefit fields are tagged with special type embeddings. These type embeddings cause the attention mechanism to more heavily weight relationships between situation information tokens and user question tokens. During decoding, the server reads the probability distribution over vocabulary tokens at each step and applies a restricted vocabulary mask that blocks generation of facility identifiers and price benefit patterns that are not present in the prompt. This vocabulary masking is computed by the server from the facility information and price benefit information loaded from the storage device. By doing so, the server enforces a technical constraint that ensures consistency of generated text with server-maintained records.

The server performs training and fine-tuning of the generative AI model prior to deployment. The server uses supervised learning with a loss function such as cross-entropy over token sequences. The server constructs training examples in which prompt sentences include structured situation information and target sequences include correct, concise recommendations or explanations. During training, the server performs gradient-based optimization of model weights, for example using an adaptive optimizer. The server optionally applies data augmentation by perturbing wording of questions, including synonyms and paraphrases, while keeping the same structured context. This improves robustness of the model to diverse user expressions while keeping strong binding to the underlying structured data. The server thus improves accuracy and stability of the model with respect to the particular problem of location-dependent price benefits.

The server further processes emotional state information. The terminal acquires voice information and character information from the user. The terminal transmits these data to the server, and the server uses an auxiliary neural network, such as a recurrent or convolutional network, to infer emotional state categories. The server maps acoustic features or linguistic features to an emotional label and an intensity score. The server encapsulates emotional state information into dedicated prompt segments, for example:

“User's emotional state: slightly frustrated and in a hurry.

Adjust your response to be brief and to prioritize high-discount options.”

The server uses this emotional state information to modify weighting parameters used in constructing the prompt and masking logic. For example, the server can adjust ranking criteria to prioritize higher discount rates over distance for users in certain emotional states. By explicitly encoding emotional state as structured data in the prompt, the server achieves more appropriate output without separately executing rule-based decision logic, thus simplifying server architecture and reducing processing steps.

The server also carries out an explicit verification step after receiving output from the generative AI model. The server parses facility names and discount descriptions from the output value and attempts to match them to facility identifiers and price benefit identifiers stored in the storage device. The server discards any portions of the output that do not satisfy consistency checks with respect to the current location information, facility information, price benefit information, and validity periods. The server optionally reconstructs a corrected explanation by combining verified structured data with text fragments from the model output. This hybrid processing reduces error, prevents display of obsolete or non-existent price benefits, and contributes to reliability of the system.

The terminal generates query information in the form of prompt sentences when the user operates a chat-like interface. The terminal accepts text input such as “What is the best coupon for vegetables this evening?” and forwards it to the server together with cached current location information and, if available, a list of recently viewed facilities. The server incorporates these inputs into new prompt sentences and repeats the processing described above. The terminal renders the response information and price benefit information on the display, showing, for example, store names, distances, discount rates, expiration times, and usage conditions. The terminal can also highlight facilities on a digital map and allow the user to tap a marker to see additional details. The collaboration between the server and the terminal thus provides a concrete user interface that is directly tied to real-world facilities and physical locations, not limited to abstract messaging.

The server improves technical performance compared with conventional systems by reducing redundant data retrieval and avoiding repeated full-table scans. The server maintains indexes for facility information and price benefit information, keyed by geospatial ranges and validity time ranges. The server uses these indexes to build concise situation information sets which it injects into prompt sentences. By limiting prompt content to a small, relevant subset of records, the server reduces prompt length and thereby lowers processing time in the generative AI model. This results in reduced CPU and memory usage on the server and any hardware accelerator, and allows the server to handle more concurrent user sessions.

The server further reduces communication load by transmitting to the terminal only summarized and filtered price benefit information rather than raw database contents. In addition, because the generative AI model is directed by prompt sentences to produce already-ranked and human-readable explanations, the server reduces the need to send multiple intermediate responses. This technical design leads to lower bandwidth consumption and fewer network round trips.

The server uses technical features that go beyond human mental processes. A human operator could not practically construct, in real time, prompt sentences that embed hundreds of structured facility and price benefit attributes, apply consistent vocabulary masking, and verify output against a dynamically changing database at interactive response speeds. The server automates these tasks with algorithmic flows, data structures, and model integration methods that materially improve the functioning of the computing system.

In alternative embodiments, the server may use different neural network architectures for the generative AI model, such as encoder-decoder architectures or hybrid transformer-recurrent models. The server may vary hyperparameters, vocabulary sets, and special token types to optimize performance for particular languages or domains. The server may also store situation information in alternative data stores, such as relational databases or in-memory key-value stores, while maintaining the same overall integration pattern of constructing prompt sentences that encode current location information, facility information, and price benefit information.

In another embodiment, the terminal may pre-process some facility information and price benefit information locally, for example caching results, computing distance locally, and only requesting incremental updates from the server. The terminal can include in the user's query a summary of locally cached data, and the server can decide whether to reuse that data or to refresh it. This further reduces server load and network usage and enhances responsiveness, while still using centralized prompt construction to maintain consistency between model outputs and the authoritative data on the server.

In summary, the server, the terminal, and the user cooperate in a system where the server constructs structured, context-rich prompt sentences that integrate user behavior history information, current location information, facility information, price benefit information, and emotional state information. The server uses a generative AI model configured with explicit constraints and data-driven masking to generate response information that is both natural in language and strictly aligned with real-time situation information. This architecture improves technical aspects of computer operation, including processing speed, memory usage, data consistency, and communication efficiency, and provides a concrete mechanism for location-dependent, user-optimized information delivery that extends beyond mere automation of human decision-making.

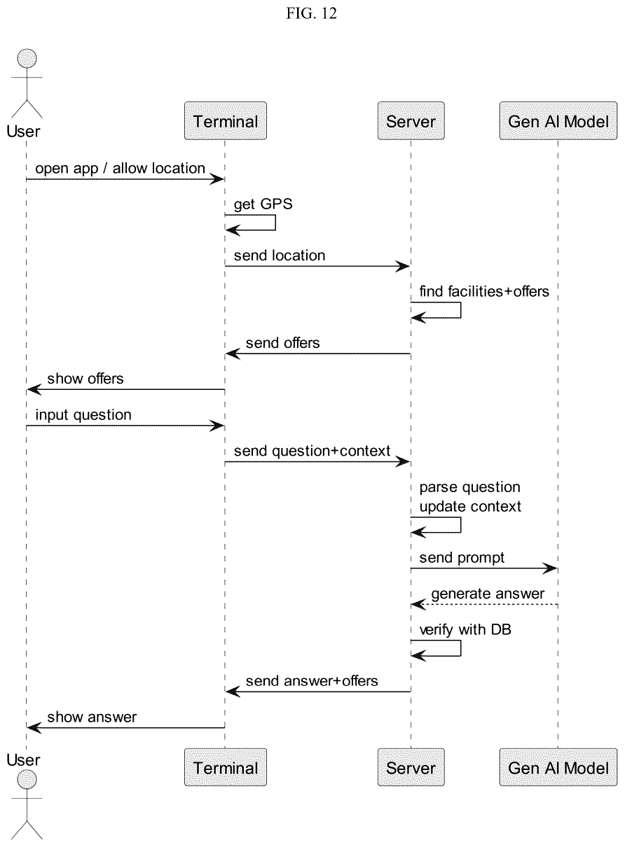

The following describes the processing flow using FIG. 12.
Step 1:

The terminal acquires current location information of the user.

The terminal receives raw signals from a positioning hardware module, converts the signals into geographic coordinates, and prepares the coordinates for transmission.

Input: sensor signals from a positioning module and system time from the terminal.

Output: a location data structure including latitude, longitude, and accuracy.

The terminal invokes an operating system location API, obtains the latest available fix, and computes a latitude/longitude pair. The terminal attaches a timestamp, an accuracy value, and a terminal identifier, and stores this as a location object in memory.
Step 2:

The terminal transmits the current location information and user context to the server.

The terminal creates a request payload that includes the location object and user identification data and sends the payload over a network.

Input: the location data structure, a user identifier, and application state information.

Output: a network packet transmitted to the server.

The terminal serializes the location object and the user identifier into a message, sets protocol headers, opens a secure channel, and writes the message bytes to the network interface.
Step 3:

The server receives and validates the transmitted data.

The server parses the network packet, checks the structure and the value range of each field, and rejects or accepts the data according to validation rules.

Input: the network packet containing the location data structure and the user identifier.

Output: a validated location record or an error condition.

The server reads the incoming message from a communication buffer, decodes the serialized data into internal objects, verifies that latitude and longitude values are within valid bounds, and confirms that the user identifier corresponds to a known account or session.
Step 4:

The server enriches the current location information with geographic attributes.

The server transforms the raw coordinates into human-readable area descriptors and geospatial index keys for efficient retrieval.

Input: the validated location record.

Output: an enriched location record containing address components and geospatial keys.

The server calls a geocoding component to map the latitude and longitude to city, district, and postal region. The server also computes a geohash or similar index value and stores the enriched record in a temporary structure for subsequent queries.
Step 5:

The server retrieves facility information in a vicinity of the enriched location.

The server searches a storage device using the geospatial keys to identify facilities located within a predefined radius of the user.

Input: the enriched location record, including the geospatial index.

Output: a list of facility records.

The server calculates a search boundary based on the radius, composes a query against a geospatial index or range-partitioned table, filters facility entries whose coordinates are inside the boundary, and loads their identifiers, categories, and coordinates into memory.
Step 6:

The server retrieves price benefit information associated with the facilities.

The server performs lookup operations in a storage device to obtain active discounts or offers for each facility record.

Input: the list of facility records.

Output: a list of price benefit records grouped by facility.

The server iterates over facility identifiers, issues index-based queries to a discount table, applies conditions on validity periods and status fields, and aggregates the matched price benefit entries into a facility-to-benefit mapping structure.
Step 7:

The server prepares situation information for subsequent processing.

The server merges location, facility, and price benefit data into a single structured context object.

Input: the enriched location record, the list of facility records, and the list of price benefit records.

Output: a situation information object.

The server organizes the data into a hierarchical structure that includes user position, nearby facility attributes, and associated price benefits. The server assigns internal keys and formats numeric values, such as distances and discount rates, to fixed precision.
Step 8:

The server transmits initial price benefit information to the terminal.

The server generates a summary representation of the situation information and sends it to the terminal for immediate display.

Input: the situation information object.

Output: a response message containing summarized facility and price benefit information.

The server selects a subset of facilities and price benefits based on ranking rules, serializes them into a compact message, and writes the message to a network channel connected to the terminal.
Step 9:

The terminal receives and presents the initial price benefit information.

The terminal decodes the response message, converts the data into display elements, and shows them on a user interface.

Input: the response message from the server.

Output: a rendered list or map view displaying facilities and price benefits.

The terminal parses the serialized data, instantiates local facility and price benefit objects, computes basic layout parameters, and draws textual and graphical elements on the display, such as facility names, distances, and discount descriptions.
Step 10:

The user reviews the displayed information and optionally selects or refines a query.

The user observes the presented offers, interacts with the interface, and may enter a follow-up natural language question.

Input: visual information on the display and the user's recognition and decision.

Output: user action signals such as touch gestures and natural language text.

The user touches interface components, such as buttons or text fields, and types or speaks a query like “Are there any 10%-off coupons I can use at a supermarket within 1 km?”
Step 11:

The terminal acquires the user's natural language query and sends it to the server.

The terminal converts user input into digital text data and attaches current context information before transmission.

Input: user touch events, keyboard events, or speech recognition results.

Output: a query request message containing the user's question and current context.

The terminal collects the text string representing the question, associates it with the latest known location and display state, packs these into a structured message, and transmits the message to the server over the network.
Step 12:

The server performs analysis of the natural language query and updates situation information.

The server interprets the query in terms of constraints on facilities and price benefits and refreshes situation information if the location or time has changed.

Input: the query request message and previously stored situation information.

Output: an updated situation information object and extracted query intent.

The server applies a natural language analysis component to segment and tag the query text, identifies constraints such as discount rate thresholds and distance limits, and recomputes the set of relevant facilities and price benefits if necessary.
Step 13:

The server determines an emotional state of the user when available.

The server processes voice features and textual features to infer an emotional label and intensity, which are used as part of context.

Input: voice information, character information, and auxiliary user data.

Output: an emotional state descriptor.

The server extracts acoustic features, lexical features, and syntactic features, applies a trained classifier network to these features, and outputs a label such as “neutral,” “in a hurry,” or “frustrated,” along with a confidence score.
Step 14:

The server constructs a prompt sentence for the generative AI model.

The server combines the updated situation information, the query intent, and the emotional state into a structured text sequence that functions as an instruction to the model.

Input: the updated situation information, the extracted query intent, and the emotional state descriptor.

### Output: a Prompt Sentence.

The server arranges the data into ordered sections, inserts explicit markers for roles and context, converts numeric values into readable phrases, and concatenates the elements into a single text, for example:

“You are an assistant that recommends real, currently available coupons based only on the provided data.

User's current location: latitude 35.6812, longitude 139.7671.

Nearby facilities and coupons: . . .

User's emotional state: slightly frustrated and in a hurry.

User's question: ‘Are there any 10%-off coupons I can use at a supermarket within 1 km?’

Based on the above data, answer in concise English. Only mention facilities and coupons that are included in the list and that are within 1 km.”
Step 15:

The server encodes the prompt sentence and applies control parameters for the generative AI model.

The server transforms the prompt sentence into token sequences and sets hyperparameters and vocabulary masks that constrain model output.

Input: the prompt sentence and a configuration profile for the generative AI model.

Output: tokenized input and a set of control parameters.

The server tokenizes the text into subword units, selects a decoding temperature and maximum output length, and generates a mask that forbids tokens corresponding to facilities or price benefits not included in the situation information.
Step 16:

The server invokes the generative AI model with the encoded prompt.

The server forwards the tokenized input and the control parameters to the model engine and obtains a token sequence representing the generated response.

Input: tokenized prompt input and control parameters.

Output: a sequence of output tokens generated by the model.

The server loads the tokens into model input buffers, triggers the forward pass through the neural network layers, and iteratively decodes tokens while applying the vocabulary mask and stopping conditions, until a termination symbol is produced.
Step 17:

The server decodes and parses the generated response.

The server converts the token sequence into text and identifies references to facilities and price benefits.

Input: the sequence of output tokens.

Output: a natural language response text and a set of referenced identifiers or names.

The server maps tokens back to text segments, reconstructs sentences, searches for phrases that match facility names or discount patterns, and records positions and mappings between text segments and internal identifiers.
Step 18:

The server verifies the consistency of the generated response with stored data.

The server checks each referenced facility and price benefit against current records and removes any inconsistent content.

Input: the natural language response text, the referenced identifiers or names, and current facility and price benefit records.

Output: a corrected response text and an associated list of verified recommendations.

The server cross-references identifiers, validates that discounts are active and within the requested range, eliminates or replaces any mismatched text, and reconstructs a coherent explanation that only includes verified data.
Step 19:

The server prepares a final response message for the terminal.

The server packages the corrected response text and structured recommendation data into a transmission format.

Input: the corrected response text and the list of verified recommendations.

Output: a response message containing both text and structured recommendation fields.

The server creates a payload containing the explanation text, identifiers, facility names, discount descriptions, and validity information, and serializes the payload into a message suitable for network transfer.
Step 20:

The terminal receives the final response and updates the user interface.

The terminal parses the response message, creates display elements, and updates visual components on the screen.

Input: the response message from the server.

Output: an updated user interface showing conversational text and interactive recommendation elements.

The terminal converts the text into a chat-style display, associates recommendation items with actions such as opening a map or showing a coupon code, and renders updated content so that the user can see and select the recommended price benefits.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information provision systems that rely on natural language interfaces suffer from several technical deficiencies in how they process, integrate, and use heterogeneous data (such as user context, usage history, and content databases) to generate responses. In many existing architectures, natural-language questions from users are handled in a largely monolithic or rule-based pipeline, in which parsing, database query generation, ranking, and response generation are hard-coded and rigid. As a result, the system has difficulty adapting to variations in user intent, context, and dialog history, leading to inefficient use of computing resources and increased processing latency.

First, conventional systems do not flexibly couple natural language understanding with backend retrieval conditions. The mapping from user questions to search conditions for storage devices is often implemented as static rules or fixed templates. When the question is ambiguous, incomplete, or context-dependent, the system either produces overly broad queries, which burden storage devices and networks with unnecessary retrieval operations, or overly narrow queries, which fail to retrieve relevant data. This mismatch degrades overall system throughput and increases average response time.

Second, conventional systems do not effectively leverage user-specific usage history and contextual information, such as location, time, and past interactions, in a unified, machine-guided manner. Usage history and context are either ignored or processed separately from the main query pipeline. Consequently, ranking and selection of candidate information items (for example, facilities and benefits) are not systematically optimized based on quantitative evaluation values. This leads to inefficient ranking algorithms, additional post-processing steps, and redundant computation on the processor and storage device.

Third, conventional conversational systems lack a robust mechanism for iteratively updating their internal query and ranking logic in response to dialog history. Follow-up questions and incremental user operations are not systematically accumulated and used to update search conditions, ranking criteria, and prompt design. As a result, the system repeatedly restarts the processing from scratch for each user input. This causes unnecessary re-computation in the processor, redundant database accesses, and increased latency, and prevents the system from converging to more efficient, user-tailored processing paths over time.

Fourth, while generative models have recently been introduced for natural-language response generation, these models are often used in a simplistic way: they are provided with a single, generic prompt and then asked to both retrieve and generate content. This approach lacks a structured division of labor between deterministic components (such as external storage, deterministic ranking logic, and explicit evaluation computation) and the generative component. As a result, the model may perform implicit, uncontrolled retrieval, may hallucinate non-existent data, or may require large prompt payloads, all of which degrade the technical performance of the overall system in terms of memory usage, network bandwidth, and processing time.

Accordingly, there is a need for a system and method that technically improve the way a processor cooperates with a generative model, a natural language processing function, and a storage device. In particular, there is a need for an architecture in which the processor: (i) decomposes the overall task into explicit functional stages; (ii) uses the generative model via structured prompt sentences to control analysis, query formulation, ranking, and response generation; (iii) integrates user context and usage history into the query and ranking stages based on quantifiable evaluation values; and (iv) incrementally updates its internal state based on dialog history. By addressing these deficiencies, the invention aims to improve the efficiency, scalability, and reliability of computer-implemented information provision, thereby achieving a concrete improvement in computer technology itself, rather than merely automating a human mental process.

The specific processing by the specific processing unit 290 of the data processing device 12 in Example 2 is realized by the following means.

The present invention provides a server comprising a processor and a storage device that stores user-related information, the processor being configured to receive, from a terminal operated by a user, a natural-language question and associated context information including location information, time information, and user identification information, record the received information as inquiry data in the storage device, invoke an external natural language processing function to generate a structured analysis result including at least an intention, a target type, a period condition, and a location condition, determine search conditions for the storage device based on the structured analysis result, generate a query to the storage device using the structured analysis result and usage history information of the user, retrieve a data set including facility information, benefit information, and user attribute information in accordance with the query, calculate evaluation values for elements of the data set based on distance information, usage frequency, and discount conditions, perform ranking of the elements based on the evaluation values, select, from the ranked data set, a plurality of candidate information items to be recommended to the user, generate structured data for each of the candidate information items including at least a recommendation reason, an application condition, and a valid period, construct and input a prompt sentence to a generative AI model, the prompt sentence including the natural-language question, the structured data, and a dialogue-form output condition such that the generative AI model generates a natural-language response sentence summarizing the candidate information items and optimized in accordance with a usage situation and a usage tendency of the user, and transmit response data including the natural-language response sentence and the candidate information items to the terminal for display. This enables the server to implement a technically improved, staged processing pipeline in which deterministic computation of search conditions, retrieval, and ranking is explicitly separated from generative response formulation, in which user context, usage history, and dialog history are systematically integrated into the query and ranking logic, and in which prompt-driven cooperation between the processor and the generative AI model reduces unnecessary retrievals and re-computation, thereby improving computational efficiency, response latency, and reliability of computer-based information provision.

The term “processor” refers to a hardware computation unit, such as a central processing unit or a processing circuit, that executes instructions to perform data acquisition, analysis, retrieval, ranking, generation, and communication operations according to a program.

The term “storage device” refers to a physical information storage unit, such as a memory device or a storage medium, that stores user-related information, inquiry data, usage history information, and data sets including facility information, benefit information, and user attribute information in a machine-readable form.

The term “terminal” refers to an information processing apparatus operated by a user, such as a communication device or a user interface device, that transmits natural-language questions and context information to the server and receives and displays response data.

The term “user-related information” refers to information associated with a particular user, including but not limited to user identification information, usage history information, preference information, attribute information, and context information.

The term “natural-language question” refers to an input sentence or utterance expressed in a human language, received from the user via the terminal, that requests information, assistance, or content from the system.

The term “context information” refers to auxiliary information associated with a natural-language question, including at least location information, time information, and user identification information, which is used to interpret the question and to determine retrieval and ranking conditions.

The term “location information” refers to data indicating a geographic position, such as coordinates or region identifiers, associated with the terminal or the user at the time of the question.

The term “time information” refers to data indicating a point in time or a time period, such as a timestamp or date, associated with the occurrence of the natural-language question or the validity of information.

The term “user identification information” refers to data that uniquely or pseudo-uniquely identifies a user within the system, such as an identifier, an account reference, or a session token.

The term “inquiry data” refers to stored records that represent one or more natural-language questions and associated context information, accumulated over time as part of the system's interaction history with the user.

The term “external natural language processing function” refers to an information processing capability implemented outside the main processor, such as an external service or module, that performs operations including parsing, intent detection, entity extraction, and structuring of natural-language input.

The term “structured analysis result” refers to a machine-readable representation of the output of the natural language processing function, including defined fields such as intention, target type, period condition, and location condition.

The term “intention” refers to a classification label or semantic representation that indicates a type of user request or goal inferred from the natural-language question.

The term “target type” refers to a category or class of entities or information, such as a type of facility or a type of benefit, specified or implied in the natural-language question.

The term “period condition” refers to a temporal constraint, such as a date or time range, that is extracted from the natural-language question or context information and used as a condition for searching or filtering data.

The term “location condition” refers to a spatial constraint or geographic limitation, such as a region or distance range, that is extracted from the natural-language question or context information and used as a condition for searching or filtering data.

The term “search conditions” refers to one or more constraints, parameters, or criteria derived from the structured analysis result and other information, which are used by the processor to form queries to the storage device.

The term “usage history information” refers to records of past interactions or activities of the user, including past questions, facility visits, benefit usage, and related timestamps, that are stored in the storage device.

The term “query” refers to a machine-readable retrieval request, such as a database query, that is generated by the processor based on the structured analysis result and usage history information and is applied to the storage device.

The term “data set” refers to a collection of records retrieved from the storage device in response to a query, the records including at least facility information, benefit information, and user attribute information.

The term “facility information” refers to data describing locations or service-providing entities, such as stores, venues, or service sites, including attributes such as category, name, and geographic position.

The term “benefit information” refers to data describing incentives or advantageous conditions, such as discounts, coupons, or special offers, including attributes such as discount rate, conditions of use, and validity period.

The term “user attribute information” refers to descriptive data associated with a user, such as membership level, preference categories, or demographic attributes, which may affect applicability or ranking of information.

The term “distance information” refers to data representing a measure of spatial separation, such as a distance between the user's location and a facility's location, used for evaluation and ranking.

The term “usage frequency” refers to a quantitative measure indicating how often a user has interacted with a facility, a category, or a type of benefit, derived from usage history information.

The term “discount condition” refers to a constraint or requirement under which a benefit becomes applicable, such as a minimum purchase amount, time-of-day restriction, or user membership level requirement.

The term “evaluation value” refers to a numerical or otherwise ordered value assigned to an element of the data set based on one or more factors including distance information, usage frequency, and discount condition, used to compare and rank elements.

The term “ranking” refers to an ordering of elements in the data set based on evaluation values or other criteria, such that higher-ranked elements are considered more suitable for recommendation.

The term “candidate information items” refers to selected elements from the ranked data set that the processor determines as suitable to be recommended to the user.

The term “structured data” refers to a machine-readable representation associated with each candidate information item, including at least a recommendation reason, an application condition, and a valid period, and suitable for systematic processing and prompt construction.

The term “recommendation reason” refers to explanatory data indicating why a particular candidate information item is suggested to the user, based on factors such as usage history, evaluation values, or user attributes.

The term “application condition” refers to a specific requirement or rule that must be satisfied for a candidate information item, such as a benefit, to be usable by the user.

The term “valid period” refers to a time range or expiry specification during which a candidate information item, such as a benefit, remains applicable.

The term “prompt sentence” refers to a text string or sequence of symbols constructed by the processor and provided as input to a generative AI model, the text string containing instructions, context, and structured data that guide the generation of output by the model.

The term “generative AI model” refers to a machine learning-based generative system, such as a language model, that receives a prompt sentence and outputs a generated result, including natural-language text, according to learned parameters.

The term “dialogue-form output condition” refers to a specification, included in a prompt sentence, that constrains or instructs the generative AI model to produce output in a conversational or interactive style suitable for user dialogue.

The term “natural-language response sentence” refers to a sentence or collection of sentences generated by the generative AI model in a human language, summarizing candidate information items and adapted to the user's usage situation and usage tendency.

The term “usage situation” refers to a current or recent state related to the user's environment and behavior, including factors such as location, time, and ongoing activities, as understood by the system.

The term “usage tendency” refers to a pattern or preference inferred from the user's past behavior and interactions, such as preferred categories of facilities or typical spending habits.

The term “response data” refers to information transmitted from the server to the terminal, including at least the natural-language response sentence and identifiers or representations of candidate information items, for presentation to the user.

The term “external information processing function” refers to a processing capability implemented outside the main processor, such as a separate module or service, that performs specialized processing including emotion estimation or natural language parsing.

The term “emotional index” refers to a representation of an inferred emotional state of the user, such as a score, category, or vector, obtained from analysis of voice information or character information.

The term “expression style” refers to a set of characteristics of generated text, including tone, politeness level, length, and degree of detail, which can be adjusted based on the emotional index and usage history information.

The term “dialogue history” refers to accumulated records of past interactions between the user and the system, including previous questions, responses, and operations, used to adapt subsequent processing and information provision.

The term “additional questions or operation information” refers to follow-up natural-language inputs or user interface actions received from the terminal after an initial question, which are used to refine search conditions, ranking, and prompt construction.

In the embodiments described below, a server, a terminal, and a user cooperate to implement the claimed system. The server executes computer programs stored in a storage device. The programs are implemented, for example, on a general-purpose server computer including a central processing unit (CPU), a main memory, a non-volatile storage device such as a solid-state drive (SSD), and a network interface, operating under an operating system such as a general-purpose server operating system.

The server uses software components including: a web server program such as a generic HTTP server, an application framework such as a general-purpose server-side framework, a database management system such as a relational database management system, a natural language processing API client, and a client library for communicating with a generative AI model. The server stores user-related information, inquiry data, and data sets including facility information, benefit information, and user attribute information in the database management system.

The terminal is realized by a communication device such as a smartphone, a tablet computer, or a personal computer including a processor, a memory, a display unit, an input unit, a location acquisition unit, and a communication interface. The terminal executes an application program or a web browser to provide a graphical user interface. The user operates the terminal to input natural-language questions, to confirm natural-language response sentences, and to select candidate information items.

The user operates the terminal to input a natural-language question, such as “Which stores can I use coupons at today?” or “Are there any coupons I can use at nearby cafes?”. The terminal acquires context information including the current geographic position obtained from a location acquisition module, time information obtained from a system clock, and user identification information stored in a local storage area. The terminal packages the natural-language question and the context information into a structured request and transmits the request to the server via a communication network.

The server receives the request and stores the natural-language question and the context information as inquiry data in the storage device. The server uses the natural language processing API client to send the natural-language question to an external natural language processing function. The external natural language processing function is implemented by a machine learning model such as a neural network-based text classifier and sequence tagger that has been trained on a large corpus of text data. This model performs tokenization, part-of-speech tagging, intent classification, and entity extraction. The server receives from the external function a structured analysis result including an intention label, a target type, a period condition, and a location condition.

The server uses the structured analysis result to determine search conditions for the storage device. The server uses the intention label to select a retrieval pattern, uses the period condition to generate date range constraints, and uses the location condition together with the location information to generate spatial constraints. The server retrieves usage history information of the user, including records of past facility visits and past benefit usage, from the database management system. The server uses these records to derive usage frequency measures and preference indicators for categories of facilities.

The server generates a query to the database management system based on the determined search conditions and the usage history information. The query is constructed to retrieve facility information, benefit information, and user attribute information relevant to the natural-language question. For example, the server retrieves facilities within a predetermined distance from the user's location, benefits whose valid periods include a specified date, and user attributes such as membership level that affect benefit applicability. The server uses database indexes for facility location, category, and validity period to reduce search time and improve I/O efficiency.

The server calculates evaluation values for elements of the retrieved data set by combining distance information, usage frequency, discount conditions, and possibly other quantitative features. The server uses a scoring function such as a weighted linear combination of normalized distance, visit count, and discount rate. The server may further include features derived from user attributes, such as a membership-level bonus factor. The server stores the evaluation values in memory and sorts the elements according to the evaluation values to perform ranking. The ranking process relies on in-memory sorting algorithms optimized for numeric scores, which reduces latency as compared with naive rule-based filtering.

The server selects a plurality of candidate information items from the top-ranked elements. For each candidate information item, the server generates structured data including a recommendation reason, an application condition, and a valid period. The server determines the recommendation reason, for example, by inspecting which factors most strongly contributed to the evaluation value, such as high usage frequency or high discount rate. The server creates human-readable explanations for the recommendation reason by mapping factor combinations to explanation templates.

The server constructs a prompt sentence for a generative AI model. The generative AI model is a trained neural network such as a transformer-based language model that maps sequences of tokens representing the prompt sentence to sequences of tokens representing a natural-language response sentence. The server encodes the original natural-language question, the structured data describing candidate information items, and constraints on the dialogue-form output into a single textual prompt sentence.

For example, the server constructs a prompt sentence such as:

“The user is asking: ‘Which stores can I use coupons at today?’

Today is [current date]. The user's membership level is [membership level].

Here is a list of recommended coupons:
1. Facility: Cafe A, Category: cafe, Distance: about 300 meters, Discount: 10% off drinks, Valid until [date], Conditions: valid after 3 PM only, Reason: you often visit this cafe.
2. Facility: Supermarket B, Category: supermarket, Distance: about 800 meters, Discount: 500 units off purchases over 3,000 units, Valid until [date], Conditions: one coupon per customer, Reason: this coupon offers a high discount.

Please answer the user in concise, friendly language suitable for a smartphone screen.

Mention the facility names, discount details, important conditions, and why they are recommended.”

As another example, the server constructs a prompt sentence such as:

“The user is asking: ‘Are there any coupons valid this weekend for supermarkets?’ ‘This weekend’refers to [date range].

Below are relevant coupons for supermarkets this weekend:
1. Facility: Supermarket X, Distance: about 500 meters, Discount: 5% off all items, Valid from [start date] to [end date], Conditions: no minimum purchase amount, Reason: close to the user and valid all weekend.
2. Facility: Supermarket Y, Distance: about 1500 meters, Discount: 1000 units off purchases over 5,000 units, Valid from [start date] to [end date], Conditions: one coupon per day, Reason: high discount for large purchases.

Explain to the user which coupons are available this weekend at supermarkets.

Use simple, clear language suitable for a mobile application and mention the main discount, validity dates, distance, and important conditions.”

The server transmits the prompt sentence to the generative AI model through an API. The generative AI model has been previously trained using supervised learning and possibly reinforcement learning with human feedback. During training, the model minimizes a loss function such as a cross-entropy loss between predicted tokens and ground-truth tokens. The model uses a network of multiple self-attention layers, feedforward layers, and normalization layers, and stores learned weights in the storage device of a computing platform providing the generative AI model service. The generative AI model receives the prompt sentence, converts it into token sequences, and calculates token probability distributions using matrix multiplications and nonlinear activation functions. The model outputs a sequence of tokens representing a natural-language response sentence.

The server receives the generated natural-language response sentence and adds metadata such as identifiers of candidate information items. The server assembles response data including the natural-language response sentence and the candidate information items and sends the response data back to the terminal. The terminal displays the natural-language response sentence on the display unit and presents the candidate information items as selectable elements. The user views the information and may select an item to display detailed conditions.

The server may further use an external information processing function to estimate an emotional state of the user based on voice information or character information contained in the user's input. The external information processing function may include a neural network trained to map acoustic features or textual features to emotional categories or continuous affective scores. The server obtains an emotional index from this external function and adjusts the selection criteria for candidate information items and the expression style of the natural-language response sentence. For example, when the emotional index indicates user frustration, the server lowers thresholds for distance and increases priority for simpler benefits, and the server modifies the prompt sentence to request a more polite and reassuring tone.

The server accumulates additional questions or operation information sent from the terminal as new inquiry data and new usage history information. The server updates search conditions, ranking parameters, and prompt sentence patterns based on this dialogue history. For example, the server increases weights for categories that the user frequently selects and reduces the number of candidate items presented when the user often abandons viewing long lists. The server thereby forms a feedback loop in which user interactions influence subsequent internal processing.

This architecture provides specific improvements to computer technology. The server separates deterministic operations (such as structured analysis, search, evaluation, and ranking) from generative operations (such as natural-language response formulation). This separation allows the server to constrain the generative AI model to operate on a reduced, preselected set of candidate items, thereby reducing prompt length, network traffic between the server and the generative AI model provider, and token-level computation inside the neural network. The server also improves caching behavior in the database management system by generating more targeted queries guided by the structured analysis result, which reduces unnecessary data scanning.

The server uses numeric evaluation values and explicit ranking algorithms to narrow the data set before invoking the generative AI model. This narrowing directly reduces the computational burden on the generative AI model because fewer items need to be described in the prompt sentence. The server's ability to integrate user usage history and context into the ranking phase yields more accurate recommendations, which reduces the need for repeated user queries and follow-up corrections, thereby improving overall throughput and response times in practice.

The server constructs the prompt sentence according to non-conventional rules that take into account the structure of the candidate data, the dialogue-form output condition, and the emotional index. Rather than merely forwarding user input to the generative AI model, the server transforms the internal state (including evaluation values, reasons, and conditions) into a structured narrative that guides the generative AI model's attention towards relevant information. This reduces the risk of hallucinated content and misaligned answers, improves the precision of generated responses, and stabilizes the behavior of the model across diverse user queries.

The server applies an iterative update mechanism in which dialogue history alters not only content but also internal ranking and prompt patterns. This mechanism is not a simple replay of historical data but a technical control loop that adjusts algorithmic weights and constraints to achieve better convergence in retrieval and ranking. Through this control loop, the server reduces redundant retrievals, shortens queries, and increases cache hit ratios, producing measurable improvements in CPU utilization, memory usage, and network bandwidth consumption.

The embodiments may adopt different variants. The server may implement the database management system as a relational database, a key-value store, or a graph database. The external natural language processing function may be integrated locally within the same hardware as the server or may be provided by an external service. The generative AI model may be a large-scale transformer, a smaller domain-specific language model, or a hybrid architecture combining retrieval-augmented generation with the ranking algorithm described above.

The terminal may present the natural-language response sentence as text, as synthesized speech, or as a combination of text and graphical elements. The terminal may additionally cache recent response data to support offline browsing of benefit information, further reducing communication demands.

By explicitly coordinating structured analysis, database retrieval, numeric ranking, and controlled generative output through a program executed on the server, these embodiments realize a technical solution that improves the efficiency, reliability, and scalability of computer-based information provision. The improvement does not simply automate human decision-making but uses numeric evaluation, machine-learned language structures, and iterative system-level control to achieve results that are not attainable by manual processing in a practical time or scale.

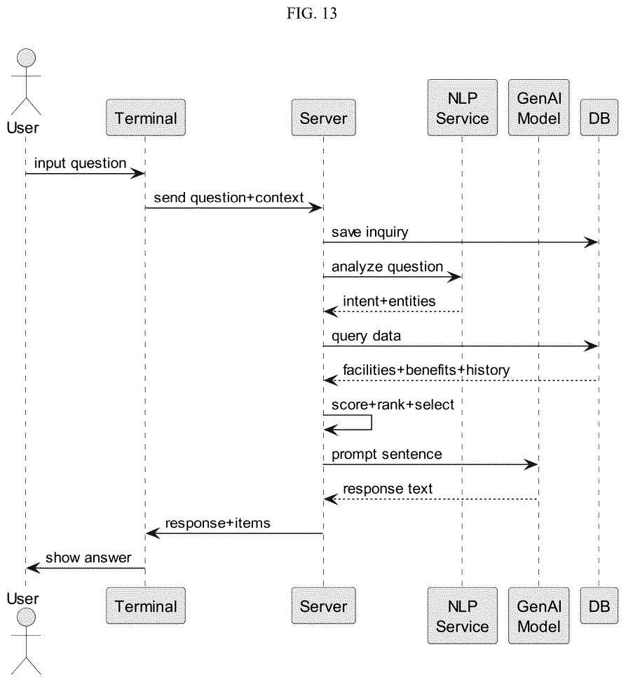

The following describes the processing flow using FIG. 13.
Step 1:

User operates the terminal to input a natural-language question.

User enters a text such as “Which stores can I use coupons at today?” into an input field displayed on the terminal and confirms the input by pressing a send button.

Input: User's keystrokes or voice that is converted into a text string on the terminal.

Output: A completed natural-language question string held in the terminal's memory.
Step 2:

Terminal collects context information and constructs a request.

Terminal acquires current location from a location acquisition module, acquires current time from a system clock, and reads user identification information from a local storage area. Terminal combines the natural-language question with the context information into a structured request object.

Input: Natural-language question string, current geographic coordinates, current timestamp, user ID stored locally.

Output: A structured request containing the question, location information, time information, and user identification information.
Step 3:

Terminal transmits the structured request to the server.

Terminal uses a communication interface to send the structured request to a predefined server endpoint over a network using a communication protocol. Terminal converts the structured request into a network packet stream and ensures delivery to the server.

Input: Structured request object containing question and context.

Output: Network packets carrying the request that arrive at the server's network interface.
Step 4:

Server receives the structured request and stores inquiry data.

Server, via a web server component, parses the network packets, reconstructs the structured request, and extracts the natural-language question and context information. Server records this information as inquiry data in a storage device, associating it with a unique inquiry identifier.

Input: Network packets representing the structured request from the terminal.

Output: Inquiry data record stored in a database, including question text, location, time, and user ID.
Step 5:

Server sends the question to an external natural language processing function and obtains a structured analysis result.

Server takes the question text from the inquiry data and calls an external natural language processing API. Server transmits the question text and optional language parameters. The external function performs tokenization, intent classification, and entity extraction. Server receives a structured analysis including intention, target type, period condition, and location condition.

Input: Question text and associated context identifiers.

Output: Structured analysis result containing an intention label, a target type, a period condition, and a location condition.
Step 6:

Server determines search conditions for the storage device based on the structured analysis result.

Server interprets the intention to select a retrieval pattern, interprets the period condition to form date range constraints, and interprets the location condition to form spatial constraints combined with the user's current position. Server merges these constraints into a search condition object that will be used to form database queries.

Input: Structured analysis result and context fields such as timestamp and location.

Output: Search condition object defining temporal range, spatial range, and target categories.
Step 7:

Server retrieves usage history information for the user.

Server uses the user identification information contained in the inquiry data to query a usage history table in the database management system. Server retrieves records of past interactions, including facility visits and benefit usage. Server aggregates these records into metrics such as visit counts per facility and per category.

Input: User ID and search condition object.

Output: Usage history information structured as aggregated metrics per facility and per category.
Step 8:

Server generates a database query and retrieves a raw data set.

Server uses the search condition object and usage history information to construct a database query. The query filters facilities by location and category, filters benefits by validity period and applicability, and joins user attribute tables. Server sends the query to the database management system and receives a raw data set that matches the constraints.

Input: Search condition object and usage history information.

Output: Raw data set including facility information, benefit information, and user attribute information.
Step 9:

Server computes evaluation values for elements of the raw data set.

Server iterates over each element in the raw data set and computes a numeric evaluation value. Server derives distance information from facility coordinates and user location, derives usage frequency from usage history metrics, and reads discount conditions and rates from benefit records. Server applies a scoring formula to combine normalized distance, usage frequency, and discount characteristics into a single score.

Input: Raw data set, user location, usage history metrics.

Output: Annotated data set where each element includes an evaluation value.
Step 10:

Server performs ranking and selects candidate information items.

Server sorts the annotated data set in descending order of evaluation value using a sorting algorithm. Server selects a predetermined number of top-ranked elements as candidate information items.

Input: Annotated data set with evaluation values.

Output: Ordered list of candidate information items selected for recommendation.
Step 11:

Server generates structured data for each candidate information item.

Server, for each candidate item, compiles structured data fields including facility name, benefit description, valid period, application conditions, and a recommendation reason derived from evaluation factors. Server determines which factor contributed most to the score and maps that factor to a textual recommendation reason.

Input: Candidate information items and their evaluation components.

Output: Structured candidate data including recommendation reason, application condition, and valid period.
Step 12:

Server constructs a prompt sentence for the generative AI model.

Server combines the original natural-language question, the structured candidate data, and constraints on output style (such as “concise”, “friendly”, and “suitable for smartphone display”) into a single textual prompt sentence. Server formats the prompt sentence so that the generative AI model can clearly identify the question, the list of candidates, and the instructions.

Input: Original question text, structured candidate data, output style constraints.

Output: A prompt sentence string ready to be transmitted to the generative AI model.
Step 13:

Server sends the prompt sentence to the generative AI model and receives a natural-language response sentence.

Server uses a client library to send the prompt sentence to a generative AI model endpoint. The generative AI model processes the prompt using its internal neural network and generates a sequence of tokens representing a natural-language response sentence. Server receives the generated response as a text string from the endpoint.

Input: Prompt sentence string.

Output: Natural-language response sentence text generated based on the prompt.
Step 14:

Server assembles response data for the terminal.

Server creates a response object that includes the natural-language response sentence and identifiers or summaries of the candidate information items. Server may attach additional metadata such as facility identifiers for deep-linking to detail views on the terminal.

Input: Natural-language response sentence and structured candidate data.

Output: Response data object ready for transmission to the terminal.
Step 15:

Server transmits the response data to the terminal.

Server encodes the response data into a network message and sends it to the terminal over the network via a server-side communication interface.

Input: Response data object.

Output: Network packets containing the response data, delivered to the terminal.
Step 16:

Terminal receives and parses the response data.

Terminal reads the network packets, reconstructs the response data, and parses the components into a natural-language response sentence and a list of candidate information items. Terminal maps each candidate to display elements in its user interface layout.

Input: Network packets carrying the response data.

Output: Parsed response content residing in the terminal's memory, including response text and candidate list.
Step 17:

Terminal displays the natural-language response sentence and candidate information items.

Terminal renders the response sentence in a text area and displays the candidate information items as a list or grid with facility names, benefit descriptions, and validity periods. Terminal associates each item with selectable controls, such as buttons for viewing details or using the benefit.

Input: Parsed response content.

Output: Visual output on the display that the user can read and interact with.
Step 18:

User reviews the response and optionally issues a follow-up question.

User reads the natural-language response sentence and examines the list of candidate items. User may select an item to view details or may input a follow-up question such as “Only show cafes” using the same input field.

Input: Displayed text and controls on the terminal.

Output: New user action, either selection of an item or entry of a follow-up question.
Step 19:

Terminal records follow-up actions and sends updated information to the server.

Terminal, upon receiving a user selection or follow-up question, records the action as new interaction data and constructs an updated request including the new question or operation information. Terminal transmits this updated request to the server in the same way as the initial request.

Input: User's follow-up question or selection command.

Output: Updated structured request representing additional inquiry data and operation information sent to the server.
Step 20:

Server updates usage history and internal parameters based on dialogue history.

Server receives the updated request, records the new inquiry or operation information as extended usage history, and updates weighting factors or thresholds used in evaluation value computation and candidate selection. Server thereby adapts ranking behavior and prompt construction logic to the evolving dialogue history.

Input: Updated structured request and existing usage history records.

Output: Updated usage history data and updated internal parameters used in subsequent processing iterations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information-provision systems that combine databases and natural language interfaces typically follow a fixed, rule-based pipeline in which user inputs are parsed, database queries are executed, and static templates are filled. Such systems suffer from several technical limitations. First, they generally treat the natural language generation component as a black-box output stage that is disconnected from upstream contextual signals such as fine-grained usage-situation data, behavioral history, geographic proximity, and real-time emotion state. As a result, the generated responses often include facility identifiers or discount offers that are outdated, not actually available in the underlying data records, or poorly matched to the user's current context. This mismatch leads to excessive error-handling logic on both the server and the terminal, increases network traffic due to repeated clarification requests, and degrades the effective throughput and reliability of the overall computer system.

Second, existing systems typically do not structure the interaction with a generative artificial intelligence model at the level of the prompt sentence itself as a first-class computational artifact. In many implementations, a single coarse prompt is used for all users and all situations, and the model response is post-filtered in an ad-hoc manner. This architecture underutilizes the computational capabilities of the generative model while increasing the burden on downstream parsing and verification processes. It also complicates scaling, because the server must perform repeated, complex post-processing on free-form text, consuming processor cycles and memory resources.

Third, traditional recommendation engines that rely on static scoring functions or simple machine-learning models are not configured to drive a generative model via structured prompts that encode both database-selection constraints and presentation-control constraints. Consequently, such engines cannot programmatically constrain the generative model to operate only within a verified subset of data records, nor can they reliably control the form in which the response is delivered to heterogeneous user terminals (for example, list view, map view, notification view, or interactive dialog view). This lack of alignment between structured data and generated text gives rise to inconsistencies between what is displayed and what can actually be redeemed, increasing the likelihood of user-visible errors and server-side correction traffic.

Fourth, systems that attempt to include user emotion or real-time context often bolt on sentiment analysis or simple mood tags without integrating those signals into the generative process at the prompt level. In such designs, emotion is treated as a secondary annotation that may influence color or icon choices in the user interface, but does not guide the selection or phrasing of the generated content in a computationally principled way. This results in either superficial personalization or complex, hard-to-maintain branching logic on the server, both of which reduce the efficiency and maintainability of the software architecture.

Accordingly, there is a need for a technically improved information-provision system in which a processor systematically constructs and manages prompt sentences supplied to a generative artificial intelligence model based on integrated usage-situation data, purchase-history data, and emotion-state data, and in which the outputs of the generative model are programmatically verified and reconciled with structured database records. Such a system should reduce inconsistencies between generated text and stored data, reduce the amount of ad-hoc post-processing logic and round-trip communication, and improve the overall throughput, reliability, and scalability of the computer system as a whole.

The specific processing by the specific processing unit 290 of the data processing device 12 in Application Example 2 is realized by the following means.

The present invention provides a server comprising a processor configured to acquire usage-situation data including user behavior history, position information, and environment information; search an information storage device for facility information and price-reduction information based on the usage-situation data; and generate, as a first-class computational artifact, a prompt sentence that encodes a selection of the facility information and the price-reduction information and that instructs a generative artificial intelligence model to generate response content constrained by that selection, the processor being further configured to input the prompt sentence to the generative artificial intelligence model. The processor is also configured to analyze audio data or character data from a user by speech recognition and natural language processing to identify inquiry content, to generate corresponding prompt sentences that specify interactive response behavior, to analyze purchase-history data and usage-tendency data by statistical processing and machine-learning processing to identify preference characteristics, to construct additional prompt sentences that encode individualized recommendation constraints and presentation constraints, to input the prompt sentences to the generative artificial intelligence model, to analyze natural-language text output from the generative artificial intelligence model, to collate entities described in the natural-language text with facility records and price-reduction records stored in the information storage device to perform verification, and to generate response data that links the verified natural-language text with structured identifiers for the facility information and the price-reduction information, the processor being further configured to transmit the response data and associated display-control information to a user terminal for presentation in a format compatible with display-control conditions of the user terminal. This enables the server-side computer system to integrate retrieval, analysis, generative prompting, and verification into a unified processing pipeline that reduces inconsistencies between generated text and stored data, lowers the computational overhead of ad-hoc post-processing, improves the determinism and controllability of outputs from the generative artificial intelligence model, and enhances overall system performance and scalability in providing context-aware, emotion-aware, and terminal-adapted information to users.

The term “system” refers to a combination of one or more hardware devices and software components that cooperate to execute the processing described herein, including at least a server-side apparatus and one or more user terminals.

The term “processor” refers to one or more hardware processing units, such as a central processing unit, a graphics processing unit, or a dedicated accelerator, capable of executing machine-readable instructions to perform data processing operations described in this specification and claims.

The term “usage-situation data” refers to information representing a state of use of services or products by a user, including but not limited to behavior history, position information, time information, device context, and surrounding environment information.

The term “user behavior history” refers to data indicating past actions of a user in relation to services or products, including accessed resources, selected options, redeemed offers, and interaction logs recorded over time.

The term “position information” refers to geographical location data of a user or a terminal, expressed for example by latitude and longitude coordinates, altitude, or other spatial identifiers obtained from a positioning subsystem.

The term “environment information” refers to contextual data describing circumstances around the user or terminal, including but not limited to time of day, network status, nearby wireless access points, and sensor outputs from the terminal or external devices.

The term “information storage device” refers to a data storage resource, such as a memory device or a storage subsystem, that stores structured or unstructured data records including facility records, price-reduction records, and user-related records.

The term “facility information” refers to data describing service-providing or goods-providing locations, including identifiers, names, categories, addresses, coordinates, opening hours, and other attributes.

The term “price-reduction information” refers to data describing conditions for purchasing goods or services at a price lower than a reference price, including coupon data, discount rate data, validity period data, and usage condition data.

The term “prompt sentence” refers to a machine-generated or machine-assembled natural-language or structured-language string that is supplied as an input instruction to a generative artificial intelligence model to control generation of output content.

The term “generative artificial intelligence model” refers to a trained computational model that generates text or other data in response to input, based on statistical relationships learned from training data, and that accepts at least one prompt sentence as an input parameter.

The term “audio data” refers to digital representations of sound signals obtained from a microphone or another acoustic sensor, including sampled waveforms or encoded audio streams.

The term “character data” refers to textual data composed of characters, symbols, or tokens, including text input directly by a user and text obtained by converting audio data using speech recognition processing.

The term “speech recognition processing” refers to processing that converts audio data representing spoken language into corresponding character data using acoustic models, language models, or pattern recognition algorithms.

The term “natural language processing” refers to processing that analyzes, interprets, or transforms human language text, including tokenization, part-of-speech tagging, syntactic parsing, entity extraction, and intent classification.

The term “inquiry content” refers to structured data that represents the substance of a user query, including at least a question component, an intent component, and a target category derived from user input.

The term “purchase-history data” refers to stored records representing past purchase events of a user, including at least product identifiers, product categories, transaction times, transaction amounts, and facility identifiers.

The term “usage-tendency data” refers to data derived from or related to user-behavior or purchase-history data that indicates statistical or learned tendencies, such as frequency of use, preferred categories, or temporal patterns.

The term “statistical processing” refers to computational procedures that summarize or analyze data using statistics, including aggregation, averaging, counting, and distribution estimation.

The term “machine-learning processing” refers to computational processing that applies one or more machine-learning algorithms to data in order to detect patterns, classify items, cluster items, or predict attributes or behaviors.

The term “preference characteristics” refers to learned or inferred attributes that represent a user's likes, dislikes, or affinities for certain categories, facilities, price ranges, or content types.

The term “purchase tendencies” refers to patterns in a user's purchasing behavior, such as frequently purchased categories, repeatedly visited facilities, or typical spending levels, derived from purchase-history data.

The term “individualized recommendation information” refers to recommendation data that is tailored to a specific user based on that user's preference characteristics, purchase tendencies, or usage-situation data.

The term “selection result” refers to structured data generated by the processor that indicates a subset of facility information and price-reduction information chosen according to one or more selection criteria.

The term “structured data” refers to data organized in a defined schema or format, such as records, fields, tables, or key-value pairs, that can be systematically processed by a computer.

The term “output style” refers to one or more properties specifying the formatting or structural pattern of information to be presented to a user, such as bullet list, paragraph, dialogue form, or tabular layout.

The term “expression tone” refers to linguistic attributes of generated text that relate to manner or attitude, such as formal, casual, polite, empathetic, or neutral tone.

The term “information amount” refers to a quantity or level of detail of content to be included in a generated output, such as the number of items, the length of text, or the depth of explanation.

The term “natural-language text” refers to text generated or processed in a human language using words, phrases, and sentences arranged according to grammatical rules of that language.

The term “facility record” refers to a data record in the information storage device that stores facility information associated with a specific facility identifier.

The term “price-reduction record” refers to a data record in the information storage device that stores price-reduction information associated with a specific discount identifier or coupon identifier.

The term “verification” refers to processing in which entities extracted from natural-language text, such as facility names or price-reduction details, are matched and checked against corresponding records in the information storage device to confirm consistency or validity.

The term “response data” refers to a data structure generated by the processor that includes at least natural-language text and associated structured data identifying facilities and price-reduction offers to be presented to a user.

The term “identifier” refers to a value that uniquely or distinctively identifies a record, entity, or item within a data set or information storage device.

The term “communication device” refers to a hardware and software subsystem that enables data exchange between the server and external devices via one or more communication networks.

The term “user terminal” refers to an end-user device, such as a communication device or a computing device, that is capable of receiving, displaying, or outputting response data and of transmitting user inputs to the server.

The term “visual display” refers to a form of output in which information is presented as images, text, icons, or other visual elements on a display apparatus.

The term “audio output” refers to a form of output in which information is presented as sound, including spoken synthesized speech or audio cues, through a speaker or similar device.

The term “emotion-estimation processing” refers to computational analysis of audio data or character data to infer an emotion state, such as happiness, sadness, tiredness, or excitement, using rule-based or learned models.

The term “emotion state” refers to a classification or representation of a user's emotional condition inferred from input data, often selected from a predefined set of emotion categories.

The term “context information” refers to composite information that combines multiple types of data, such as emotion state, usage-situation data, and purchase-history data, to describe the circumstances in which processing is performed.

The term “response sentence” refers to a natural-language text sequence generated or instructed to be generated as an answer or reaction to user input.

The term “display-control conditions” refers to parameters or constraints that determine how information is to be presented on a user terminal, including layout, modality, priority, and interaction style.

The term “control information” refers to data or instructions generated by the processor for controlling a user terminal to present response data in a particular format or through a particular user interface component.

The term “list-display format” refers to a presentation mode in which multiple items are arranged sequentially as a list, possibly with associated attributes or icons.

The term “map-display format” refers to a presentation mode in which items such as facilities are shown as markers or symbols overlaid on a geographic map representation.

The term “notification-display format” refers to a presentation mode in which information is displayed as a notification element, such as a banner, pop-up, or alert, that may appear outside a main application window.

The term “interactive-screen-display format” refers to a presentation mode in which information is displayed in a screen that supports bidirectional interaction, such as a chat interface, card-based interface, or other dialog-style user interface.

In one embodiment, a server cooperates with one or more terminals to implement an information-provision system that uses a generative AI model controlled by explicitly constructed prompt sentences. The server comprises at least one processor, a main memory, a non-volatile storage device, a network interface, and access to an information storage device such as a relational database system. The terminal comprises a processor, a memory, a display device, an audio input device, an audio output device, a positioning device, and a network communication interface.

The server executes an operating system and middleware, for example a general-purpose server operating system and an application framework. The server executes an application program that is stored in the storage device and loaded into the main memory. The program implements a plurality of functional modules, including a usage-situation acquisition module, a natural language processing module, a purchase-history analysis module, a prompt-generation module, a generative AI interface module, a verification module, and a response-delivery module.

The terminal executes an operating system, for example a mobile operating system, and an application that communicates with the server through the network interface. The terminal uses a microphone to capture user speech as audio data, and uses an integrated positioning device, such as a GPS module or a network-based location subsystem, to obtain position information. The terminal uses a local speech recognition library or a network-based speech recognition service to convert audio data into character data before transmitting it to the server. The terminal also receives response data from the server and renders it on the display device or as audio output through a loudspeaker.

The server stores, in the information storage device, a plurality of tables representing facility records, price-reduction records, user records, purchase-history records, usage-situation records, and interaction logs. In one implementation, the server uses a relational database management system such as a general SQL database. The facility records include facility identifiers, geographic coordinates, category identifiers, and attribute fields. The price-reduction records include identifiers, associated facility identifiers, discount types, discount rates, validity periods, and usage conditions. The purchase-history records include user identifiers, product identifiers, facility identifiers, transaction timestamps, and payment amounts.

The server uses the natural language processing module, which can be implemented using libraries such as a tokenization and parsing library, to perform tokenization, part-of-speech tagging, dependency parsing, and named-entity recognition on character data received from the terminal. The server implements an intent-classification algorithm that uses feature vectors constructed from token n-grams, part-of-speech tags, and entity labels. The server can use a linear classifier, a gradient-boosted decision tree, or a small neural network as an intent classifier. The classifier outputs an intent label, such as “find nearby coupons” or “request recommended products,” and confidence values.

The server uses an emotion-estimation module to infer an emotion state from audio data or character data. In one embodiment, the server applies a pre-trained transformer-based text classifier that maps text to emotion categories. The model uses token embeddings, multi-head self-attention layers, and a classification head with a softmax output. The server receives an emotion vector and selects an emotion state based on the highest probability. In an alternative embodiment, the server uses an acoustic feature extractor that computes Mel-frequency cepstral coefficients and prosodic features such as pitch and energy, and feeds them into a recurrent neural network classifier. The server fuses text-based and audio-based emotion outputs using a weighted average rule to improve robustness and accuracy.

The server analyzes purchase-history data using the purchase-history analysis module. The server loads purchase-history records for a user from the information storage device into an in-memory data structure, such as a table or array of records. The server aggregates the data by facility category, price range, and time of day. The server calculates statistical measures including frequency counts, moving averages, and category distributions. The server optionally applies a clustering algorithm, such as k-means clustering, to group users with similar purchase patterns and derive usage-tendency data. The server stores preference characteristics and purchase tendencies as feature vectors associated with each user identifier.

The server constructs prompt sentences using the prompt-generation module. The server treats each prompt sentence as a structured instruction that specifies which data have been selected from the database, which constraints apply, and what output format is requested. The server uses a deterministic template engine that fills template variables with context values such as usage-situation data, intent labels, emotion states, preference characteristics, and selected facility and price-reduction records. The server thus generates a prompt sentence in natural language that instructs the generative AI model to produce an answer under explicit constraints.

In one example, the server generates a prompt sentence of the following form: “User intent: find nearby coupons.

User emotion: tired.

User purchase pattern: frequent visits to sports stores and coffee shops.

Nearby facilities and active discounts:
1) Store A: 15% off sports shoes today.
2) Store B: buy one get one free coffee.
3) Store C: 10% off general groceries.

As a recommendation engine, generate a short English message under 120 words that first acknowledges the user's tiredness and then recommends exactly two offers that best match the user's purchase pattern and current emotion. Include facility names, discount details, and a brief reason for each choice.”

In another example, the server generates a prompt sentence as follows: “User ID: 12345.

User intent: find a celebratory coupon.

User emotion: happy.

Purchase history summary: frequently buys cakes and sweets at Bakery A and Bakery B, average spend 20 USD per visit.

Nearby facilities and coupons:
1) Bakery A—15% off cakes today.
2) Bakery B—buy 2 get 1 free pastries.
3) Cafe C—free dessert with coffee.

Generate an upbeat English message under 100 words that congratulates the user and recommends two of these offers that best fit the user's celebration mood and purchase history.”

The server sends each prompt sentence to the generative AI model through the generative AI interface module. In one embodiment, the server uses a transformer-based language model deployed on a separate computation node or accessed via a network API. The generative AI model uses an encoder-decoder architecture or a decoder-only architecture with multiple self-attention layers, positional encodings, and feed-forward sublayers. The server configures inference parameters, such as temperature, maximum token length, and top-p sampling thresholds, to control diversity and determinism of the generated text.

The server receives natural-language text from the generative AI model as a sequence of tokens. The server processes this text using the verification module. The server extracts facility names, product descriptions, and discount phrases by applying entity recognition and pattern matching. The server normalizes the extracted strings and performs matching against facility records and price-reduction records stored in the information storage device. If a facility name or discount description cannot be matched within a threshold similarity, the server discards or replaces it with a verified item. The server thereby ensures that the generated text references only facilities and price-reduction items that exist and are valid in the database.

The server constructs response data that includes the verified natural-language text and associated identifiers for the referenced facility records and price-reduction records. The server optionally includes display-control information, such as flags indicating whether each item should be shown in a list view, a map view, or a notification view. The server sends the response data to the terminal over a network connection, for example using a secure transport protocol.

The terminal receives the response data and interprets the display-control information. The terminal renders the natural-language text in a message area, and renders each associated facility and price-reduction item as interactive elements. The terminal can present a list of coupons with facility names and discount details, or can display the facilities as markers on a map based on stored coordinates. When the user selects an item, the terminal retrieves additional data, such as a barcode, from the server or from locally cached data and displays it for redemption.

The described architecture produces technical improvements beyond simple automation of human tasks. The server controls the generative AI model by constructing prompt sentences that encode constrained subsets of database records and explicit output rules. Because the server limits the model's effective search space to pre-selected data, the server reduces the probability that the model will generate references to non-existent or expired offers. As a result, the server reduces the number of error corrections and follow-up requests, thereby reducing network traffic and server load.

The server improves processing speed and computational efficiency by factoring context integration and format control into the prompt-generation stage rather than relying on heavy post-generation filtering. The server uses structured data and explicit template fields to construct prompt sentences quickly, without requiring complex ad-hoc rules. This approach reduces CPU cycles consumed by downstream parsing and decreases memory usage because fewer intermediate representations are needed.

The server improves accuracy by performing systematic verification of generated text against facility and price-reduction records. Because the verification module cross-checks entities and replaces inconsistent elements, the overall system delivers output with reduced error rates. Accurate linking of generated phrases to record identifiers also improves later analytics and logging, which, in turn, supports model-training and configuration refinement.

The server improves data management by representing usage-situation data, purchase-history data, and emotion-state data as feature vectors and structured records, and by caching derived preference characteristics. This design allows the server to reuse computed tendencies across interactions, reducing redundant computation and improving responsiveness. The server can precompute or batch-update preference characteristics using offline machine-learning processes.

The use of emotion-estimation processing yields a further technical effect. The server does not merely tag a user with an emotion label; the server incorporates the emotion state into the prompt sentence as a control condition for tone and content. The generative AI model thus generates text with controlled tone and selection criteria. For example, when the emotion state indicates fatigue, the prompt sentence instructs the model to select relaxation-related offers and adopt an empathetic tone. The specific integration of emotion into the control parameters for the generative AI model leads to improved alignment between generated content and user context, which in turn reduces the need for user corrections and contributes to more efficient interaction loops.

The server uses machine-learning algorithms in a manner that departs from conventional rule-based automation. The server learns preference characteristics and usage tendencies by optimizing model parameters with respect to an error function that measures prediction deviations between predicted categories or spend levels and actual historical data. The server uses gradient-based optimization methods to adjust weight parameters in the classifier or clustering components. In training phases, the server can augment data by generating synthetic purchase sequences or noise-perturbed feature vectors, improving robustness. These steps produce learned internal representations that are not achievable by simple manual rule definition.

In alternative embodiments, the server uses different architectures for the generative AI model. For example, the server can interface with a recurrent neural network language model, or with a mixture-of-experts model that routes tokens through specialized sub-networks. The prompt-generation module can be adapted to each architecture by adjusting instruction phrasing, maximum sequence lengths, and formatting constraints.

In another embodiment, the server deploys a local generative AI model rather than an external service. The server uses a hardware accelerator, such as a graphics processor or a tensor processor, to perform matrix operations for the transformer layers. The server loads model parameters into local memory and executes inference routines that read prompt tokens, compute attention scores, and generate token probabilities. This embodiment reduces latency and reliance on external networks, thus improving responsiveness and resilience.

In a further embodiment, the terminal performs a subset of processing, such as preliminary intent detection or local caching of facility information, to reduce communication overhead. The terminal can store a local subset of facility and price-reduction records for a frequently visited area, and can update this subset periodically based on server-side changes. When the terminal has up-to-date local data, the server can construct shorter prompt sentences containing only identifiers and summary features, reducing the amount of text transmitted and processed, thereby improving bandwidth efficiency.

In another variation, the server uses a rule-based pre-filter that enforces non-standard constraints before prompt generation. For example, the server can guarantee that all selected price-reduction offers satisfy combined conditions on distance, expiration time, and maximum concurrent redemptions. By enforcing these conditions at the data-selection stage and describing them in the prompt sentence, the server constrains the generative AI model to operate within a validated region of the state space. This integration of rule-based constraints with generative modeling yields a hybrid algorithmic framework that improves both controllability and technical reliability compared with purely generative or purely rule-based systems.

Through these embodiments and variations, the server, the terminal, and the generative AI model cooperate to implement a technically specific pipeline in which explicit prompt sentences, structured feature representations, database-backed verification, and emotion-aware control jointly improve processing speed, accuracy, data consistency, and communication efficiency. The system thus provides a concrete improvement to computer technology in the domain of context-aware, generative information provision, rather than merely automating a human mental process.

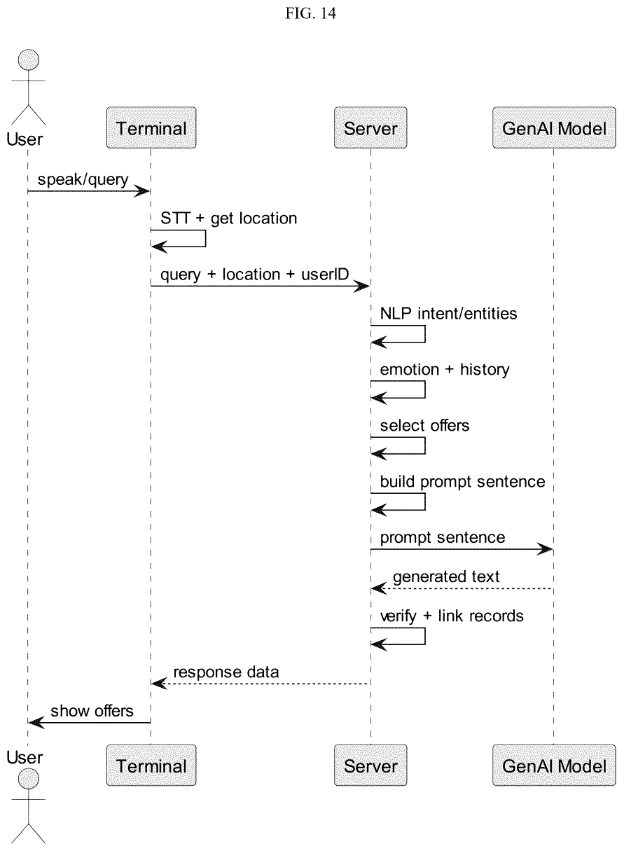

The following describes the processing flow using FIG. 14.
Step 1:

User operates the terminal to provide an input.

User speaks a request, such as “Where can I use coupons nearby?” into a microphone of the terminal, or types a text query into an input field.

Input: a spoken utterance or a typed text string from the user.

Output: raw audio data or raw character data held in the memory of the terminal.
Step 2:

Terminal converts the raw input into normalized text and acquires position information.

Terminal uses an audio capture interface to sample the user's speech and invokes a speech recognition library or a remote speech recognition service to transform the audio data into a text string. Terminal applies basic normalization, such as trimming spaces and standardizing character encoding. Terminal simultaneously activates a positioning device, such as a GPS module, to obtain latitude and longitude of the terminal.

Input: raw audio data or raw character data from Step 1, and sensor readings from the positioning device.

Output: normalized character data representing the user query, and structured position information including coordinates and timestamp.
Step 3:

Terminal constructs a request message and transmits it to the server.

Terminal encapsulates the normalized character data, the position information, a user identifier, and device metadata into a structured request object, for example a key-value set. Terminal then sends this object to the server through a network interface using a communication protocol such as HTTPS.

Input: normalized character data and position information from Step 2, and locally stored user identifier.

Output: a network request containing query text, position information, and user identifier delivered to the server.
Step 4:

Server receives and parses the request.

Server's network interface accepts the incoming message and passes it to an application handler. Server validates the user identifier and parses the request structure to extract the query text, the position information, and the user identifier. Server stores a copy of these elements in a log table for later analysis.

Input: structured request message from Step 3.

Output: internal variables representing the query text, the position coordinates, and the user identifier, and log records written to storage.
Step 5:

Server performs natural language analysis to determine intent and entities.

Server uses a natural language processing module to tokenize the query text, label parts of speech, and construct a syntactic dependency graph. Server then applies an intent-classification model that maps a feature vector derived from the tokens and entities to an intent label, such as “find_nearby_coupons” or “recommend_products”. Server also identifies domain entities such as product categories, facility types, and temporal expressions.

Input: query text from Step 4.

Output: an intent label and a set of extracted entities, represented as structured data fields.
Step 6:

Server estimates the emotion state of the user.

Server inputs the query text into an emotion-classification model, for example a neural network with an embedding layer and attention layers. Server computes an emotion probability distribution and selects the emotion category with the highest probability, such as “tired”, “happy”, or “neutral”. If audio features are available, server extracts acoustic features and fuses them with text-based features by averaging or weighted summation of scores.

Input: query text from Step 4 and, optionally, audio features derived from Step 2.

Output: an emotion label and associated confidence values stored as emotion-state data.
Step 7:

Server retrieves usage-situation data and purchase-history data.

Server queries an information storage device using the user identifier to obtain past purchase records, previous interactions, and recorded usage patterns. Server loads the resulting records into memory and aggregates them by facility category, time, and spend. Server computes statistical measures, such as frequency counts and averages, and optionally uses a clustering or classification algorithm to derive preference features.

Input: user identifier from Step 4 and database contents.

Output: purchase-history data, usage-tendency data, and derived preference characteristics for the user represented as feature vectors and summary statistics.
Step 8:

Server selects candidate facilities and price-reduction items based on position and intent.

Server uses the position coordinates and intent label to query facility tables and price-reduction tables in the information storage device. Server filters facilities by distance from the user position and by facility type compatible with the intent. Server then joins the selected facilities with currently valid price-reduction records, discarding expired or incompatible items.

Input: position information from Step 4, intent label from Step 5, and facility and price-reduction records from the database.

Output: a selection result containing candidate facilities and associated price-reduction information compiled as structured data.
Step 9:

Server constructs a context object for prompt generation.

Server combines the intent label, the extracted entities, the emotion state, the preference characteristics, and the selection result into a single context object. Server organizes this context into fields such as “user_intent”, “emotion”, “purchase_pattern”, and “nearby_offers”.

Input: intent and entities from Step 5, emotion label from Step 6, preference characteristics from Step 7, and selection result from Step 8.

Output: a structured context object representing the complete state for the current interaction.
Step 10:

Server generates a prompt sentence for the generative AI model.

Server uses a template engine to convert the context object into a linearized natural-language instruction. Server inserts values such as emotion labels, purchase summaries, and formatted lists of offers into template positions. Server includes explicit rules about tone, length, and number of recommendations in the prompt sentence.

Input: context object from Step 9.

Output: a prompt sentence in natural language that encodes data constraints, tone constraints, and format requirements.
Step 11:

Server sends the prompt sentence to the generative AI model and obtains generated text.

Server forwards the prompt sentence to a generative AI model through an interface module. Server sets inference parameters such as maximum output length and sampling configuration. The generative AI model processes the prompt sentence and emits a sequence of tokens that form a natural-language response. Server receives this token sequence and reconstructs it into a text string.

Input: prompt sentence from Step 10.

Output: generated natural-language text produced by the generative AI model.
Step 12:

Server verifies the generated text against stored records.

Server applies entity extraction to the generated text to detect facility names, product categories, and discount descriptions. Server normalizes these strings and searches the information storage device for matching facility records and price-reduction records. Server checks validity conditions such as existence, non-expiration, and consistency of discount amounts. If a mismatch is detected, server either replaces the mention with a verified item or removes the inconsistent part.

Input: generated text from Step 11 and facility and price-reduction records from the database.

Output: verified text and a mapping between text entities and record identifiers, forming response-linked structured data.
Step 13:

Server assembles response data including display-control information.

Server packages the verified text together with structured lists of facilities and price-reduction items and their identifiers into a response object. Server determines appropriate display modes based on intent and device type, such as list view or map view, and sets display-control fields accordingly.

Input: verified text and entity-to-record mapping from Step 12, and configuration rules for display.

Output: a response object containing natural-language content, structured item data, and display-control parameters.
Step 14:

Server transmits the response object to the terminal.

Server uses the network interface to send the response object back to the terminal over the communication channel. Server may compress the data or apply serialization to reduce size.

Server logs completion status for monitoring and diagnostics.

Input: response object from Step 13.

Output: network data delivered to the terminal containing all response elements.
Step 15:

Terminal receives and renders the response for the user.

Terminal parses the received response object and reads the display-control parameters.

Terminal displays the generated natural-language text in a conversation area and renders each facility and price-reduction item according to its designated mode, such as a clickable list item or a marker on a map. Terminal enables interaction so that the user can tap an item to open detailed information, show a coupon code, or start navigation.

Input: response object from Step 14.

Output: visual and optional audio output presented to the user and interactive elements ready for further user actions.
Step 16:

User interacts with the presented information and optionally issues a follow-up request.

User reviews the displayed offers, selects a desired item, or issues a new question such as “Any quieter places?” by voice or text. User actions may generate interaction logs and purchase events that the terminal records locally or sends to the server.

Input: visual or audio information from Step 15.

Output: new user actions, including item selections or new inputs, which can be processed by repeating Steps 1 to 15 with updated context.

The data generation model 58 is a so-called generative artificial intelligence (AI). Examples of the data generation model 58 include generative AIs such as ChatGPT (registered trademark) (Internet search <URL https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

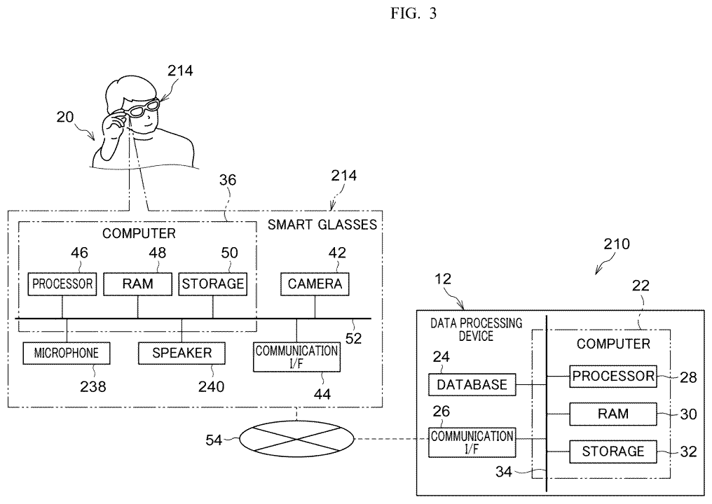

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

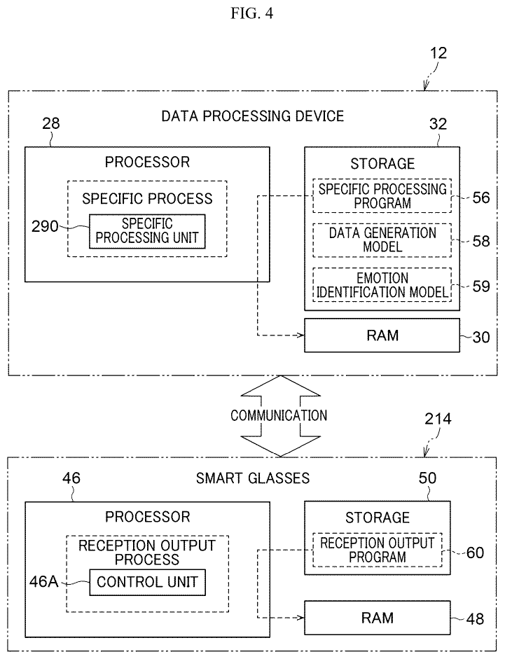

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

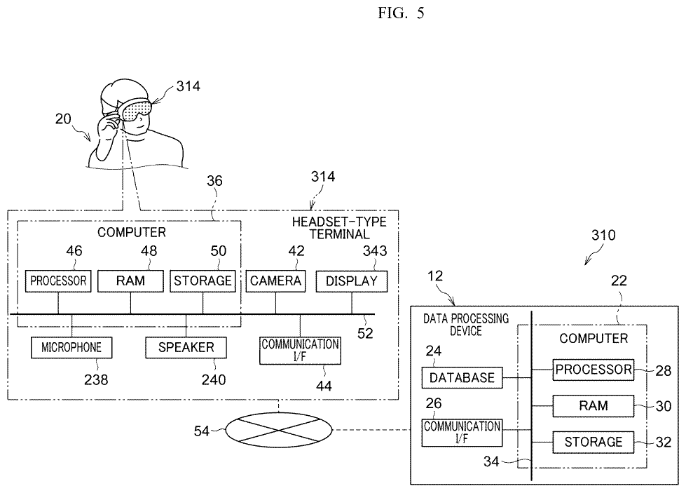

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

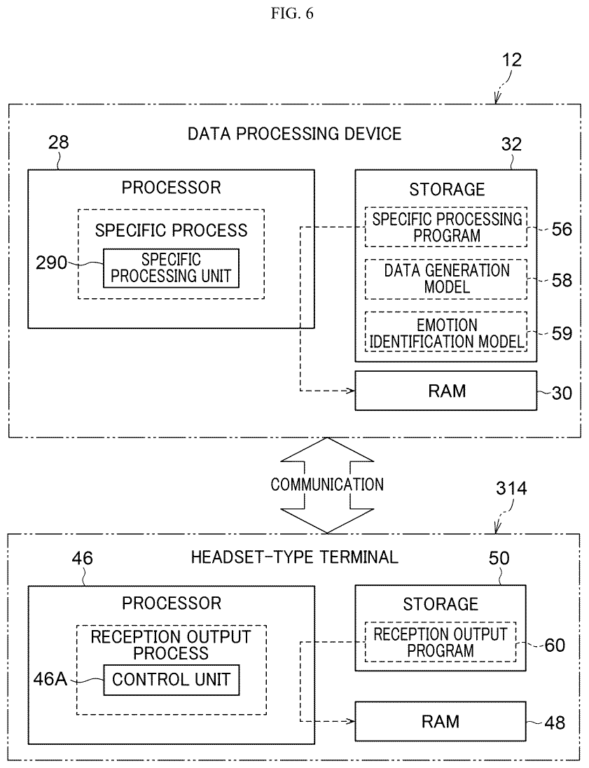

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

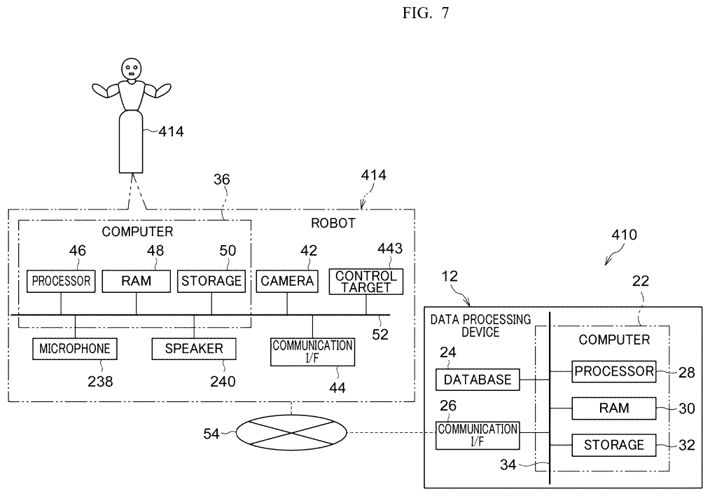

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

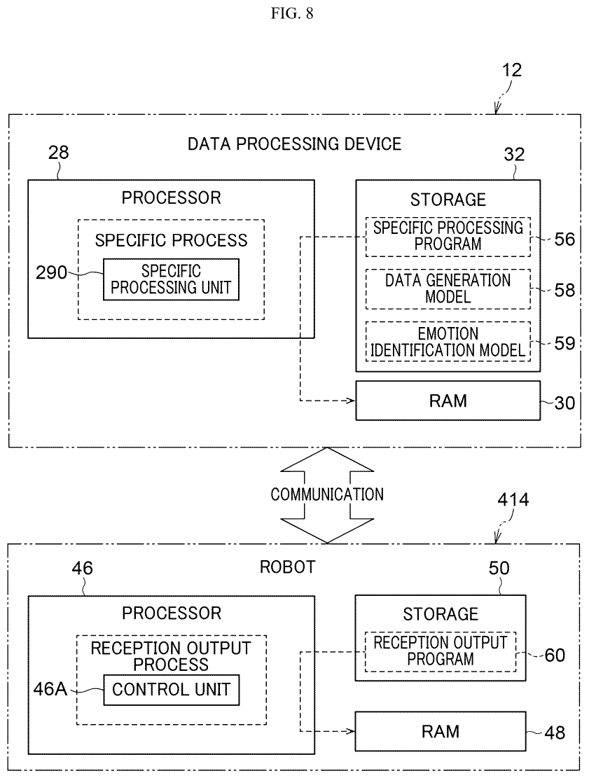

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

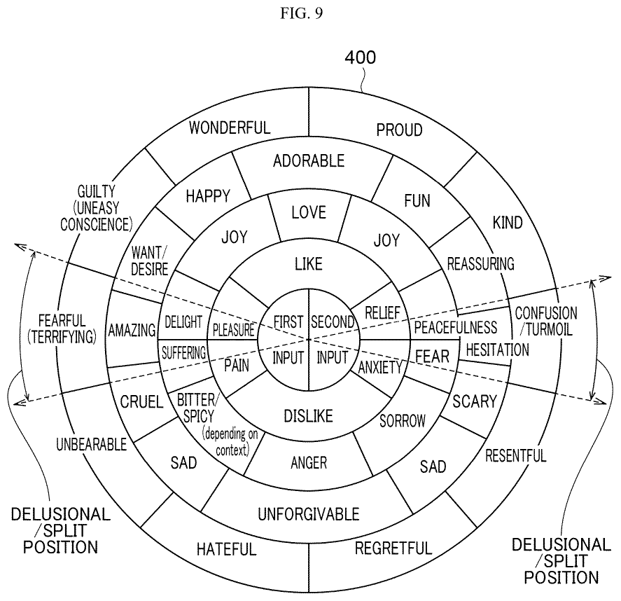

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

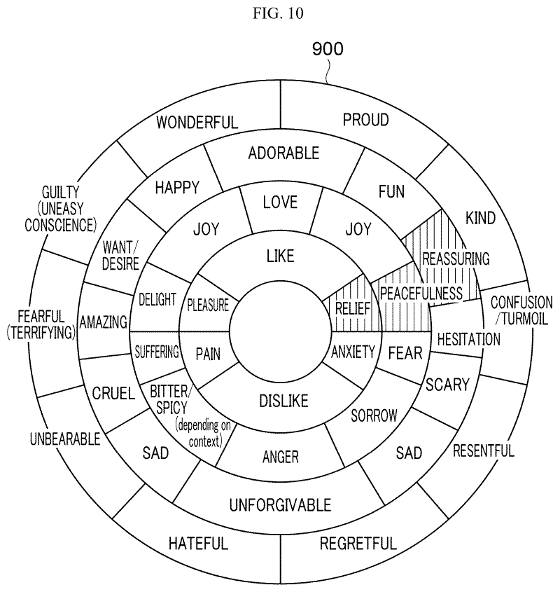

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor and a storage apparatus,
wherein the processor is configured to
determine search conditions for exploring related information from the storage apparatus based on utilization information of a user, and generate inquiry information for the storage apparatus based on the search conditions,
analyze question information expressed in a natural language and position information received from a terminal of the user, and generate search parameters including at least a facility type, a time condition, a distance condition, and a preference condition of the user on the basis of an analysis result,
transmit the inquiry information to the storage apparatus on the basis of the search parameters, and acquire search result information including facility information and discount information from the storage apparatus,
perform processing to extract and reorder presentation-target information based on the search result information and the utilization information of the user,
generate a prompt sentence to be input to a generative AI model based on the search result information and the reordered information, and describe in the prompt sentence at least the question information from the user, the search parameters, and the search result information, input the prompt sentence to the generative AI model so as to cause the generative AI model to generate response information expressed in a natural language, and generate presentation information including the response information,
transmit the presentation information to the terminal of the user via a communication line, and present the facility information and the discount information in an interactive format to the user, and
associate a plurality of pieces of the question information and the response information with each other based on dialogue identification information, store dialogue history information, and update content of a subsequent prompt sentence based on the dialogue history information.

### Supplementary 2

The system according to supplementary 1,
wherein the processor is configured to
estimate an emotional state from voice information or character information of the user, and generate the prompt sentence including content for adjusting an expression format, a detail level, and a presentation order of the prompt sentence to be input to the generative AI model in accordance with the emotional state and the utilization information of the user.

### Supplementary 3

The system according to supplementary 1,
wherein the processor is configured to
associate the response information output from the generative AI model with structured data acquired from the storage apparatus, and generate, based on a correspondence relationship between facility expressions or discount expressions included in the response information and the structured data, list information or map display information that is selectable on the terminal of the user.

### Application Example 1

### Supplementary 1

A system comprising a processor and a storage device,
wherein the processor is configured to
receive user behavior history information and, based on the user behavior history information, input a prompt sentence to a generative AI model so as to instruct the generative AI model to search related information from the storage device and to provide the related information,
receive current location information of a user from a portable terminal device, and, based on the current location information, search facility information existing within a predetermined range from the storage device,
acquire price benefit information associated with the facility information from the storage device and immediately notify the price benefit information to the portable terminal device of the user,
receive inquiry information expressed in natural language from the user, analyze the inquiry information, and, based on the inquiry information, the current location information, and the price benefit information, input a prompt sentence to the generative AI model so as to instruct the generative AI model to generate response information in an interactive format, analyze purchase history information and usage tendency information of the user and, by combining the purchase history information and the usage tendency information with the current location information, input a prompt sentence to the generative AI model so as to instruct the generative AI model to generate information optimized for the individual user, and
transmit the response information and the price benefit information generated by the generative AI model based on respective prompt sentences to the portable terminal device and control the portable terminal device so that the response information and the price benefit information are displayed on the portable terminal device.

### Supplementary 2

The system according to supplementary 1,
wherein the processor is configured to
recognize an emotional state from voice information or character information of the user, and, based on the emotional state, the current location information, and the price benefit information, input a prompt sentence to the generative AI model so as to instruct the generative AI model to adjust at least one of content and presentation format of information to be provided.

### Supplementary 3

The system according to supplementary 1,
wherein the processor is configured to
generate a prompt sentence including situation information comprising the current location information, the facility information, and the price benefit information as context, and input the prompt sentence to the generative AI model so as to control the generative AI model to generate only response information consistent with the situation information.

### Example 2

### Supplementary 1

A system comprising a processor and a storage device that stores user-related information, wherein the processor is configured to
receive, from a terminal operated by a user, a natural-language question together with context information including location information, time information, and user identification information, acquire the natural-language question and the context information, and record the acquired information as inquiry data, and input a prompt sentence to a generative AI model to instruct the generative AI model to control said acquisition and recording,
use an external natural language processing function having a natural language processing capability to analyze the natural-language question, generate a structured analysis result including at least an intention, a target type, a period condition, and a location condition, determine a search condition for the storage device based on the structured analysis result, and input a prompt sentence to the generative AI model to instruct the generative AI model to control said analysis, generation, and determination,
generate, based on the structured analysis result and usage history information of the user, a query for the storage device, search and acquire a data set including facility information, benefit information, and user attribute information in accordance with the query, calculate an evaluation value for each element of the data set based on distance information, usage frequency, and discount condition, perform ranking of the data set based on the evaluation value, and input a prompt sentence to the generative AI model to instruct the generative AI model to control said generation, search, acquisition, calculation, and ranking,
select, by using the ranked data set, a plurality of candidate pieces of information to be recommended to the user, generate structured data for each of the candidate pieces of information, the structured data including at least a recommendation reason, an application condition, and a valid period, and input a prompt sentence to the generative AI model to instruct the generative AI model to control said selection and generation,
input, to the generative AI model, a prompt sentence including the natural-language question, the structured data, and a dialogue-form output condition, and cause the generative AI model to generate a natural-language response sentence in which the candidate pieces of information are summarized and which is optimized in accordance with a usage situation and a usage tendency of the user, and input a prompt sentence to the generative AI model to instruct the generative AI model to control said generation of the natural-language response sentence, and transmit response data including the natural-language response sentence and the candidate pieces of information to the terminal, and cause the terminal to display the natural-language response sentence, and input a prompt sentence to the generative AI model to instruct the generative AI model to control said transmission and display.

### Supplementary 2

The system according to supplementary 1,
wherein the processor is configured to
use an external information processing function that estimates an emotional state from voice information or character information of the user to obtain an emotional index, adjust a selection criterion of the candidate pieces of information and an expression style of the natural-language response sentence based on the emotional index and the usage history information of the user, and input a prompt sentence to the generative AI model to instruct the generative AI model to control said obtaining and adjusting.

### Supplementary 3

The system according to supplementary 1,
wherein the processor is configured to
sequentially accumulate additional questions or operation information received from the terminal as the inquiry data and the usage history information, update the search condition, the ranking, and contents of the prompt sentence based on the sequentially accumulated information, perform information provision that is progressively optimized in accordance with a dialogue history, and input a prompt sentence to the generative AI model to instruct the generative AI model to control said accumulation, updating, and information provision.

### Application Example 2

### Supplementary 1

A system comprising a processor,
wherein the processor is configured to
acquire usage-situation data including user behavior history, position information, and environment information, and, based on the usage-situation data, search an information storage device for an information set including facility information and price-reduction information, and generate a prompt sentence for instructing a generative artificial intelligence model to select information from the information set, and input the prompt sentence to the generative artificial intelligence model,
analyze audio data or character data acquired from a user by performing speech recognition processing and natural language processing to identify inquiry content including a question, an intention, and a target category, generate a prompt sentence for instructing generation of interactive response information corresponding to the inquiry content, and input the prompt sentence to the generative artificial intelligence model,
analyze purchase-history data and usage-tendency data acquired from the information storage device by performing statistical processing and machine-learning processing to identify preference characteristics and purchase tendencies of the user, generate a prompt sentence for instructing generation of individualized recommendation information or price-reduction information based on the preference characteristics and the purchase tendencies, and input the prompt sentence to the generative artificial intelligence model,
select, based on the usage-situation data, the inquiry content, the preference characteristics, and the purchase tendencies, nearby facility information and valid price-reduction information, organize a selection result as structured data, generate a prompt sentence including the structured data and including conditions defining an output style, an expression tone, and an information amount, and input the prompt sentence to the generative artificial intelligence model,
analyze natural-language text output from the generative artificial intelligence model, collate facility names, product categories, and price-reduction contents included in the natural-language text with facility records and price-reduction records stored in the information storage device to perform verification, and generate response data including the natural-language text and facility information and price-reduction information each associated with an identifier based on a verification result, and
transmit the response data to a user terminal via a communication device and control the user terminal to perform visual display or audio output of the response data.

### Supplementary 2

The system according to supplementary 1,
wherein the processor is configured to execute emotion-estimation processing on the audio data or the character data acquired from the user to identify an emotion state, generate a prompt sentence, based on context information including the emotion state, the usage-situation data, and the purchase-history data, for instructing the generative artificial intelligence model to generate a response sentence having an expression tone and content selection corresponding to the emotion state, and input the prompt sentence to the generative artificial intelligence model.

### Supplementary 3

The system according to supplementary 1,
wherein the processor is configured to reconstruct the natural-language text output from the generative artificial intelligence model and the facility information and the price-reduction information included in the response data in accordance with display-control conditions of the user terminal, and generate control information for causing the user terminal to present the response data in at least one of a list-display format, a map-display format, a notification-display format, and an interactive-screen-display format.

What is claimed is:

1. A system comprising:
circuitry configured to:
receive, via a communication interface coupled to a packet-switched network, question information expressed in a natural language and utilization information of a user from a terminal device;
analyze the question information using a natural language processing model to extract search parameters, the search parameters comprising at least a category parameter, a temporal condition, a proximity condition, and a preference condition;
generate inquiry information for a storage device based on the search parameters and the utilization information, transmit the inquiry information to the storage device, and acquire search result information from the storage device;
extract and reorder presentation-target information from the search result information based on the utilization information;
construct a prompt sentence for input to a generative neural network model, the prompt sentence comprising at least the question information, the search parameters, and the reordered presentation-target information;
input the prompt sentence to the generative neural network model to generate response information expressed in a natural language, and transmit presentation information comprising the response information to the terminal device via the communication interface; and
associate a plurality of pieces of the question information and the response information with each other based on dialogue identification information, store dialogue history information in the storage device, and update a content of a subsequent prompt sentence based on the dialogue history information.

2. The system according to claim 1, wherein the circuitry is configured to analyze the question information by applying tokenization and semantic parsing to the question information, and to derive the search parameters from entity types and intent labels identified by the natural language processing model.

3. The system according to claim 2, wherein the circuitry is configured to weight the search parameters based on a utilization tendency derived from the utilization information, and to apply the weighted search parameters to generate the inquiry information as a structured database query.

4. The system according to claim 3, wherein the search result information comprises facility information and discount information associated with locations matching the search parameters, and the utilization information comprises a purchase history and a utilization frequency of the user.

5. The system according to claim 4, wherein the circuitry is configured to reorder the presentation-target information by computing a relevance score for each item in the search result information based on the purchase history and the utilization tendency, and sorting items in descending order of the relevance score.

6. The system according to claim 1, wherein the circuitry is configured to construct the prompt sentence by encoding the question information, the search parameters, and the reordered presentation-target information as structured text segments with associated segment identifiers, and concatenating the structured text segments into a single input sequence for the generative neural network model.

7. The system according to claim 6, wherein the circuitry is configured to configure generation parameters of the generative neural network model comprising at least a maximum output length and a sampling strategy, and to decode an output token sequence produced by forward passes of the generative neural network model into the response information.

8. The system according to claim 7, wherein the circuitry is configured to structure the presentation information to include at least the response information and associated item data, and to generate control information for causing the terminal device to present the presentation information in at least one of a list display format, a map display format, or an interactive screen display format.

9. The system according to claim 1, wherein the circuitry is configured to store the dialogue history information by associating each pair of question information and response information with a common dialogue identification value, and to update the content of the subsequent prompt sentence by prepending a summarized representation of stored dialogue history to the subsequent prompt sentence.

10. The system according to claim 9, wherein the circuitry is configured to limit a length of the dialogue history information incorporated into the subsequent prompt sentence based on a context window constraint of the generative neural network model, and to select the most recent dialogue entries for inclusion when the constraint is reached.

11. The system according to claim 1, wherein the circuitry is configured to estimate an emotional state of the user by applying an emotion estimation model to at least one of voice data or text data received from the terminal device, classify the emotional state into an emotional category, and adjust the prompt sentence to instruct the generative neural network model to generate the response information with an expression tone corresponding to the classified emotional category.

12. The system according to claim 11, wherein the circuitry is configured to derive the emotional category using a valence-arousal classification based on acoustic features extracted from voice data or sentiment scores extracted from text data, and to select a tone parameter for the generative neural network model based on the derived emotional category.

13. The system according to claim 12, wherein the circuitry is configured to reconstruct the response information and associated item data in accordance with display control conditions of the terminal device based on the classified emotional category, such that when the emotional state indicates urgency the circuitry generates a condensed response format emphasizing highest-ranked items.

14. The system according to claim 1, wherein the circuitry is configured to receive position information from the terminal device via the communication interface, and to incorporate a distance condition derived from the position information into the search parameters, the distance condition defining a geographic boundary for the search result information.

15. The system according to claim 14, wherein the circuitry is configured to update the search parameters based on a change in the position information received at a subsequent time, regenerate the inquiry information based on the updated search parameters, and transmit updated presentation information to the terminal device.

16. The system according to claim 1, wherein the circuitry is configured to perform processing to personalize the response information by analyzing a purchase history and a utilization tendency of the user derived from the utilization information, and to instruct the generative neural network model to weight information items matching the purchase history more heavily in the response information.

17. The system according to claim 1, wherein the circuitry is configured to compute a utilization status score from the utilization information by aggregating a frequency of past interactions associated with respective item categories, and to incorporate the utilization status score into the inquiry information to bias the search result information toward categories with higher utilization status scores.

18. A system comprising:
circuitry configured to:
receive, via a communication interface coupled to a packet-switched network, question information expressed in a natural language and utilization information of a user from a terminal device;
apply a natural language processing model to the question information to extract a category parameter, a temporal condition, a proximity condition, and a preference condition as search parameters;
generate a structured database query as inquiry information based on the search parameters weighted by a utilization tendency derived from the utilization information, and acquire search result information from a storage device;
compute a relevance score for each item in the search result information based on a purchase history and a utilization frequency of the user, and reorder items by the relevance score;
construct a prompt sentence by encoding the question information, the search parameters, and the reordered items as structured text segments and concatenating the segments into an input sequence;
input the prompt sentence to a transformer-based generative neural network model to generate response information expressed in a natural language, and transmit presentation information comprising the response information to the terminal device; and
associate question information and response information with dialogue identification information, store dialogue history in the storage device, and update subsequent prompt sentences by incorporating a summarized representation of stored dialogue history.

19. The system according to claim 18, wherein the circuitry is configured to apply an emotion estimation model to voice data or text data from the terminal device to classify an emotional state of the user, and to modify the prompt sentence to instruct the transformer-based generative neural network model to generate the response information with an expression tone and detail level corresponding to the classified emotional state.

20. A method comprising:
receiving, via a communication interface coupled to a packet-switched network, question information expressed in a natural language and utilization information of a user from a terminal device;
analyzing the question information using a natural language processing model to extract search parameters, the search parameters comprising at least a category parameter, a temporal condition, a proximity condition, and a preference condition;
generating inquiry information for a storage device based on the search parameters and the utilization information, transmitting the inquiry information to the storage device, and acquiring search result information from the storage device;
extracting and reordering presentation-target information from the search result information based on the utilization information;
constructing a prompt sentence for input to a generative neural network model, the prompt sentence comprising at least the question information, the search parameters, and the reordered presentation-target information;
inputting the prompt sentence to the generative neural network model to generate response information expressed in a natural language, and transmitting presentation information comprising the response information to the terminal device via the communication interface; and
associating a plurality of pieces of the question information and the response information with each other based on dialogue identification information, storing dialogue history information in the storage device, and updating a content of a subsequent prompt sentence based on the dialogue history information.
